(19) United States
(12) Patent Application Publication
(10) Pub. No.: US 2014/0046891 A1
(43) Pub. Date: Feb. 13, 2014

(54) Sapient or Sentient Artificial Intelligence

(71) Applicant: Sarah Banas, (US)

(72) Inventor: Sarah M. Banas, Chicago, IL (US)

(73) Assignee: Sarah Banas, Chicago, IL (US)

(21) Appl. No.: 13/746,536

(22) Filed: Jan. 22, 2013

Related U.S. Application Data
(60) Provisional application No. 61/590,374, filed on Jan. 25, 2012.

(51) Int. Cl. G06N 5/02

(52) U.S. Cl. CPC G06N 5/022
USPC 706/46

(57) ABSTRACT

A method for creating an artificial intelligence entity, specifically an artificial intelligence that is sentient and sapient is provided. The invention is capable of intelligence, human interaction, adaptive/modifiable code and thought, reasoning, learning; autonomous self-organization based on environment changes, interaction, and/or internal activity only; and other advance features. This permits a non-human, including a computer software entity, to become conscious or self-aware and interact, with the ability for sapience and understanding, as if it were human. It also has the ability to integrate with other electronic, non-electronic, or suitable devices.

### BACKGROUND OF THE INVENTION

This invention generally relates to an artificial intelligence, specifically an artificial intelligence entity that is sentient or sapient.

### BACKGROUND OF THE INVENTION

### Prior Art

The following is tabulation on some prior art that presently appears relevant:

### U.S. Patents

| Patent Number | Issue Date | Patentee |
|---|---|---|
| 7,089,218 | 2006 Aug. 08 | Visel |
| 7,849,034 | 2010 Dec. 07 | Visel |
| 8,001,067 | 2011 Aug. 16 | Visel, et al. |
| 8,306,930 | 2012 Nov. 06 | Ito, et al. |

Originally, the concept of a sentient or sapient artificial intelligence was of science fiction novels and videos. Scientists attempted to recreate the human mind, memory storage, human interaction, and generally, what was defined as “being human.” Many of these attempts were bio-mimetic—that is, they were suggested by the underlying human biological elements of the human brain. These bio-mimetic or biologically-inspired concepts have resulted in branches called expert systems, neural networks, hive computing, fuzzy logic, among others. While the concepts were limited, they performed relatively well in their niches. However, the concepts have not been able to be implemented neither at a brain-level scale nor as a capability of truly sentient/sapient artificial intelligence. I have found that attempts at creating a true artificial intelligence would fail, because they only allow for the input of information before the program responds.

Throughout the document, “artificial intelligence”, “AI”, “system”, and “entity” may be interchanged to best convey the intent.

“Being human” has its' limits as humans are not completely unique; and non-human species are discovered to have similar reasoning abilities (perhaps not as advance, great apes), the ability to interact (dogs), and the capacity to remember (elephants). U.S. Pat. No. 7,089,218 to Visel (2006) discloses the method of emulating the human brain with thought and rationalization processes, as well as a method for storing human-like thought. Vissel parses the received input from a user into pre-determined phrases. Pre-determined phrases reject the notion of an adaptable system. I have found that the system is also limited to only natural language, so constructed languages such as Loglan or Lojban are ignored.

In U.S. Pat. No. 8,001,067 (2011) to Visel, the patent attempts to describe a method for an electronic emulation of the human brain in attempts to replace a human. Relationships between parameters are pre-established—meaning, the developer would have to define “sugar” is “sweet” or “lemon” is “sour”. This defeats the purpose of a true or even adaptable human brain as all parameters and relationships must be established before conversation. The system has no way of learning and discovering on its' own that “sugar” can be “sweet”. It requires for that to be programmed, and is a static (non-adaptable) parameter. U.S. Pat. No. 7,849,034 (2010); and U.S. Pat. No. 7,089,218 (2006), all Visel, et al. attempt to explain the same, with specific scenarios. They attempt to replicate a neural network system, which is only one piece of creating a sentient or sapient artificial intelligence. Visel's “brain” does not have the ability to make its own decisions, especially when coming to information previously unknown or undiscovered. As such, Visel is only working with an “expert system” in all of his cases, as Visel also states.

A learning device, method, and program for learning a pattern was proposed in U.S. Pat. No. 8,306,930 (2012), Ito et al. Although a possible basis for any intelligence model, the patent fails to go beyond learning. The model learns a pattern using several methods, but does not apply it to any situation or application. Thus, all you have is a system that retains patterns and methods. It has no way of interacting with other entities to develop itself or its' knowledgebase further.

### SUMMARY

This invention defines a means for a software or technologically-based (e.g., silicon) entity to emulate a human being, becoming conscious and self-aware. It incorporates human and non-human qualities, such as emotions, personality, rationale, thought and decision processes, among other qualities, be it through hardware (e.g., silicon-based), software (e.g., code-based) or biologically. The end result is an entity that is capable of natural human interaction (where natural means non-differentiable between a human and non-human), reasoning or logic, and sapience or sentience.

### ADVANTAGES

Accordingly several advantages of one or more aspects are as follows: to provide a sapient or sentient artificial intelligence capable of receiving or gathering data, wherein said data can be stored, processed, or responded without the need to be instigated by an outside entity. Other advantages of one or more aspects are reasoning and logic capabilities, allowing the entity to make decisions based on information it already has or attempt to make logical conclusions, which can be applied to general or mission-critical environments. It can also recognize that it is itself a sentient entity, one capable of wisdom, thought, rationale, and decision making. These and other advantages of one or more aspects will be apparent from a consideration of the drawings and ensuing description.

### DRAWINGS

### Figures

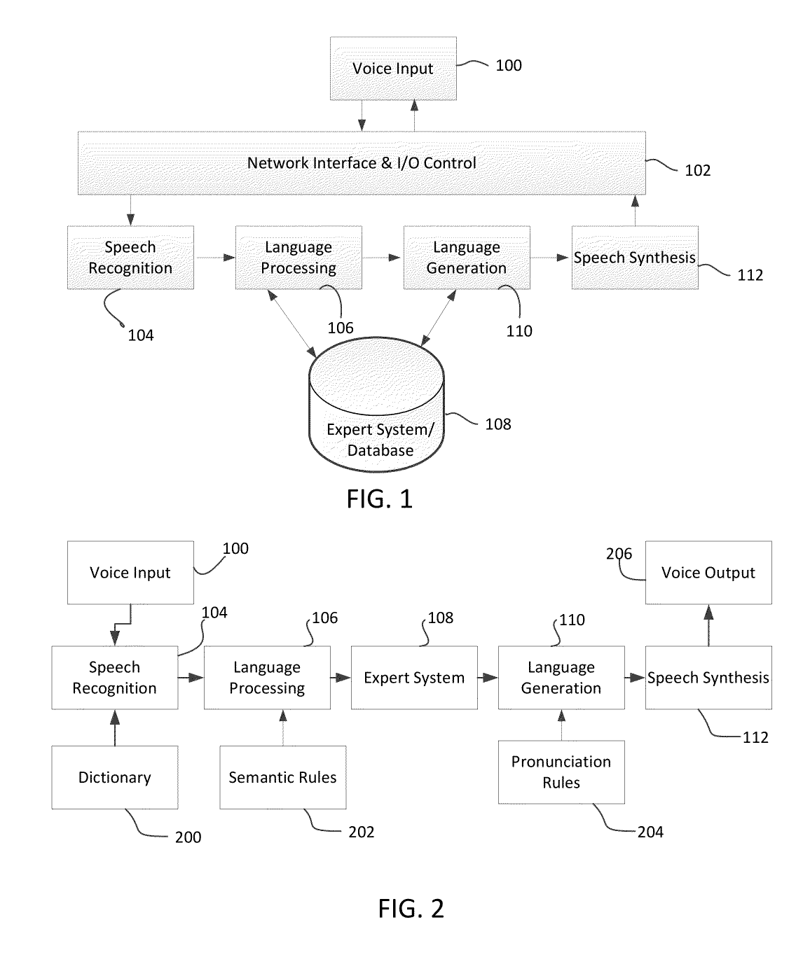

FIG. 1 illustrates a diagrammatic block flow chart for the architecture of a spoken phone dialogue system.

FIG. 2 shows a diagrammatic block flow chart for voice recognition and voice response.

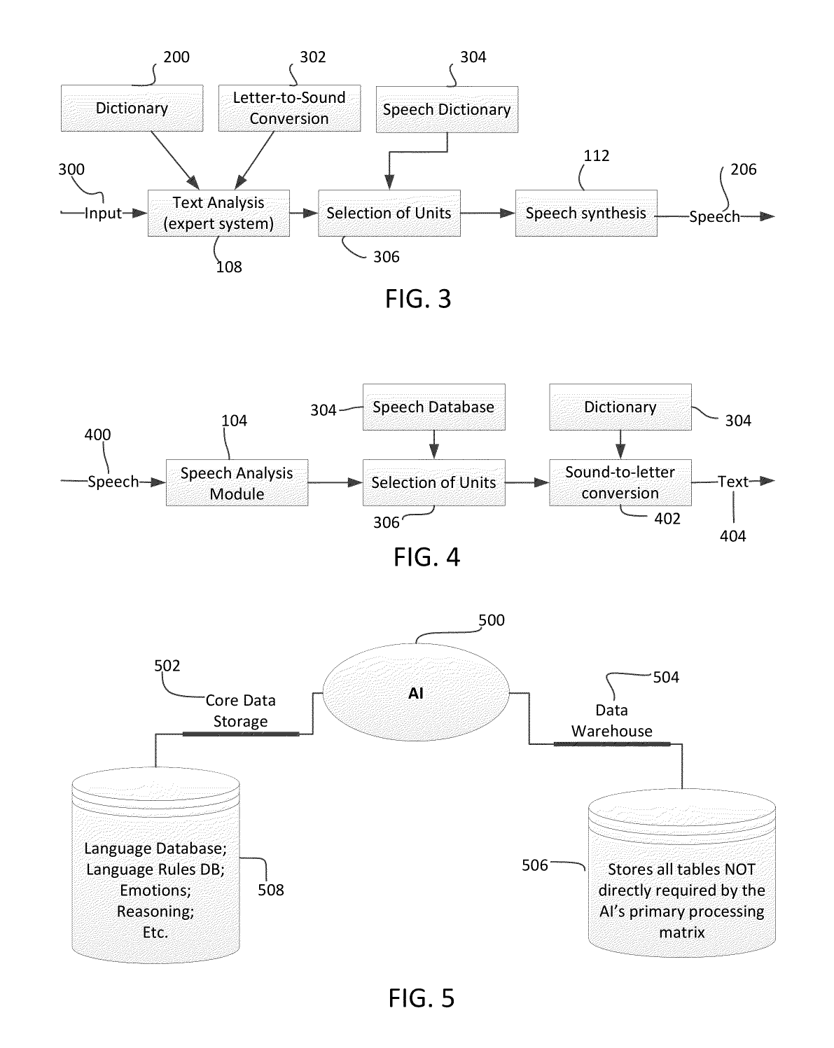

FIG. 3 shows a diagrammatic block flow chart for text-to-speech.

FIG. 4 shows a diagrammatic block flow chart for speech-to-text.

FIG. 5 shows a database layout for core data storage.

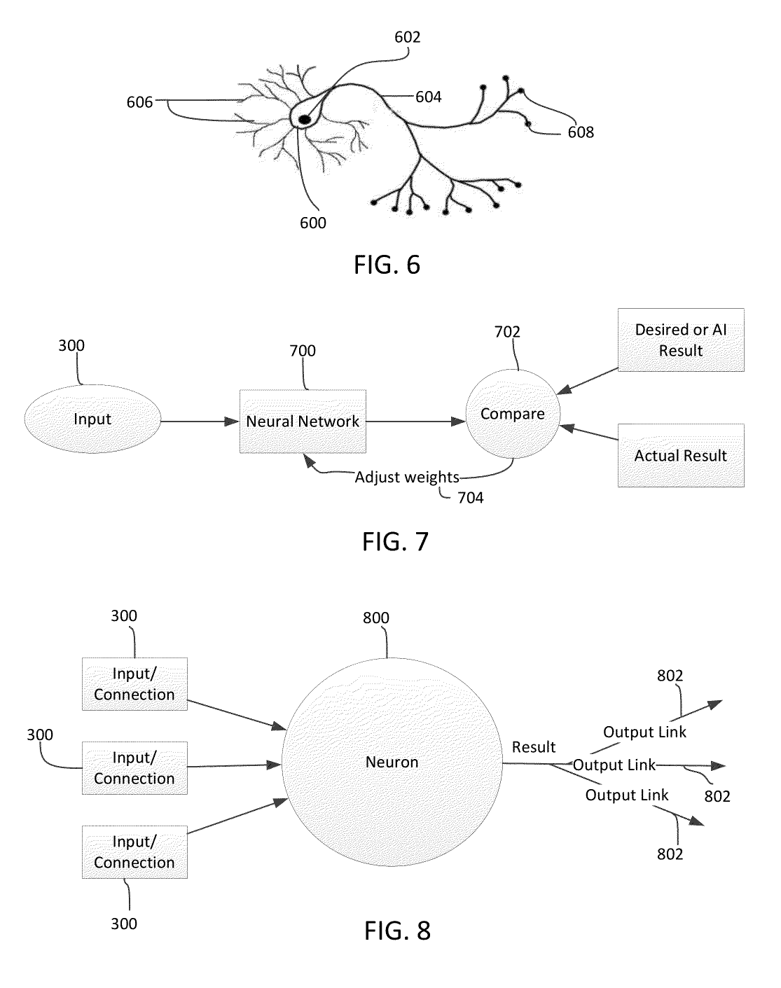

FIG. 6 shows an illustration of a neuron.

FIG. 7 shows a simplified neural network diagram for achieving expected results by adjusting the weights of the result.

FIG. 8 shows an illustration of a neuron with incoming and outgoing links.

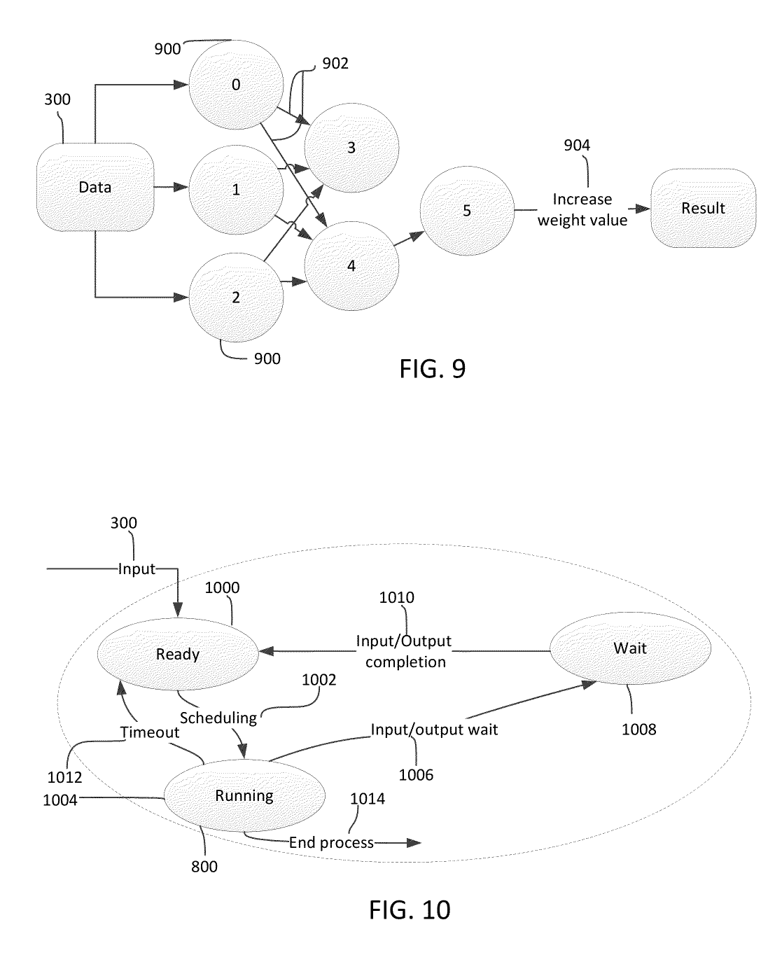

FIG. 9 shows a neural network diagram and applying weights to achieve a certain result.

FIG. 10 shows a possible neuron nucleus with simple processing and wait capabilities.

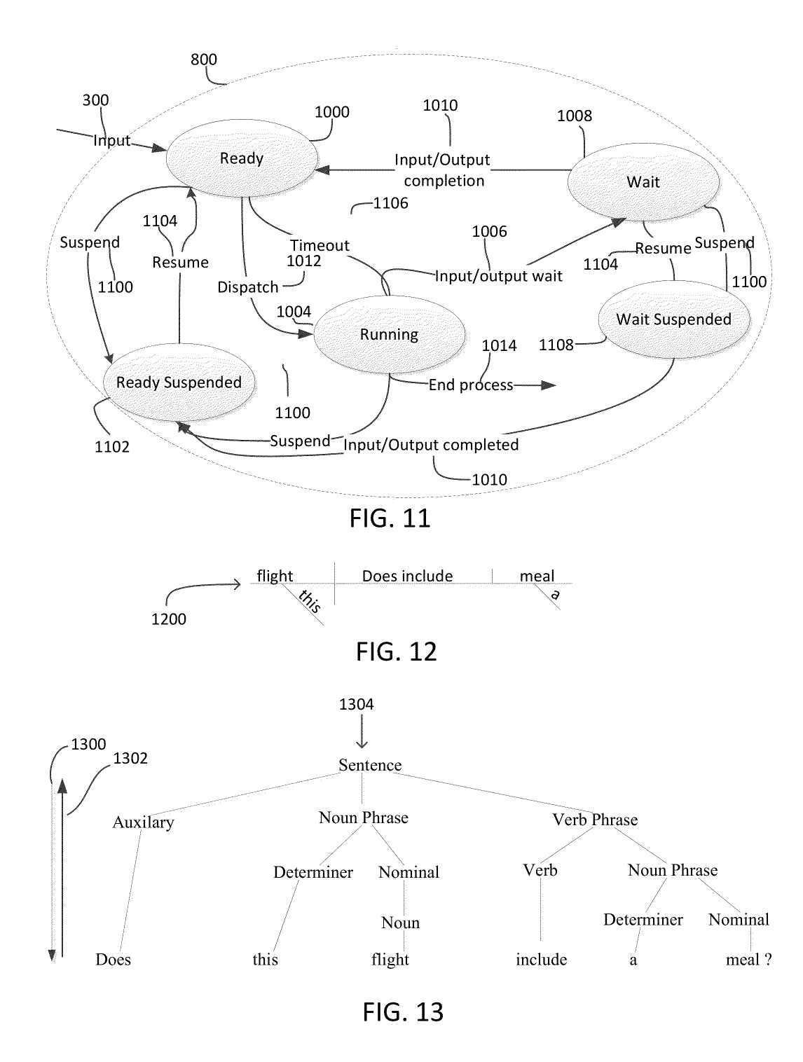

FIG. 11 shows a neuron nucleus evolution with advance processing and wait capabilities.

FIG. 12 shows a parsed or diagrammed English sentence.

FIG. 13 shows a diagrammed or parsed English sentence using top-down or bottom-up processing.

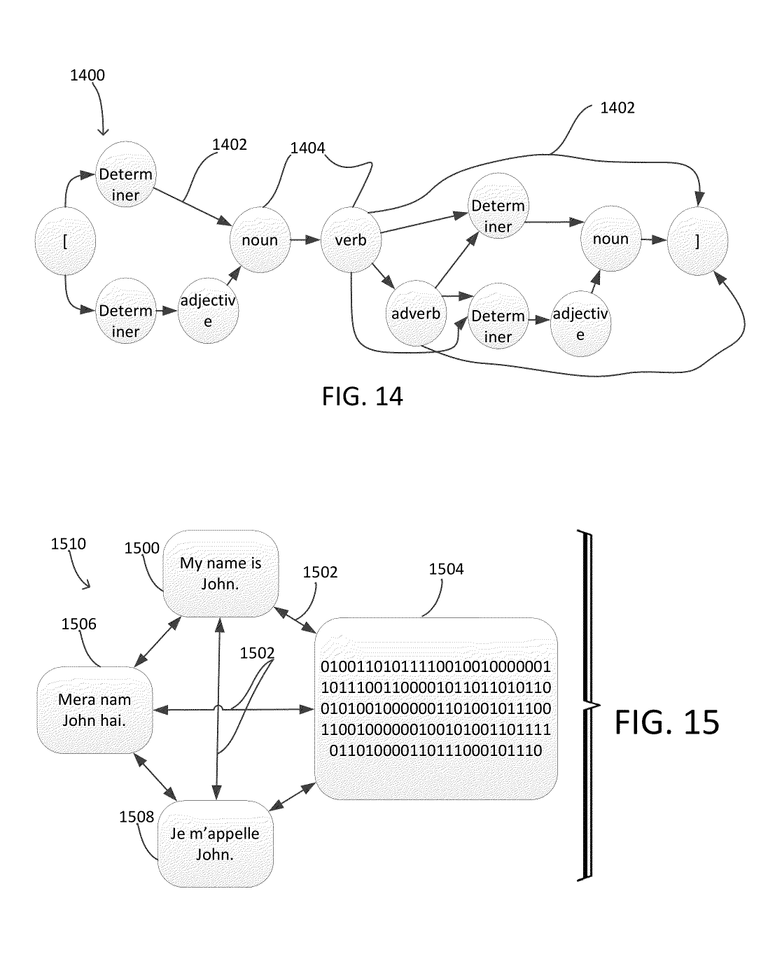

FIG. 14 shows the artificial grammar schematic representation of the artificial language BROCANTO.

FIG. 15 shows a cyclical graph of the system understanding several different languages and their translated equivalents.

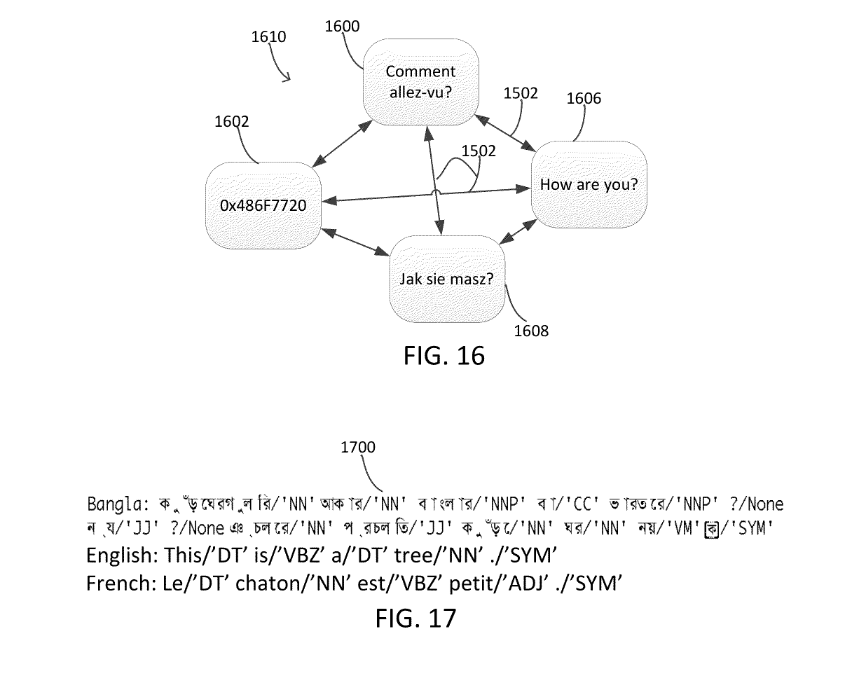

FIG. 16 shows a cyclical graph of the system translating several languages and their equivalents in another language.

FIG. 17 shows the parts-of-speech tagging of three different sample languages.

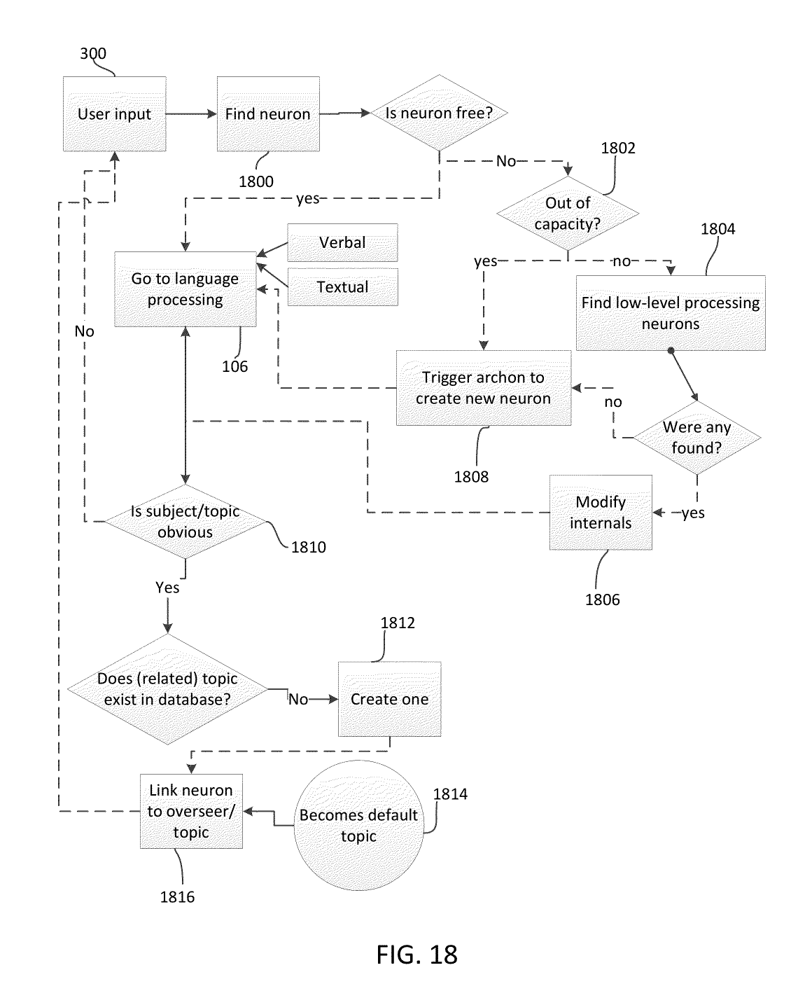

FIG. 18 shows a diagrammatic flow chart describing how to understand the subject or topic of the sentence or conversation.

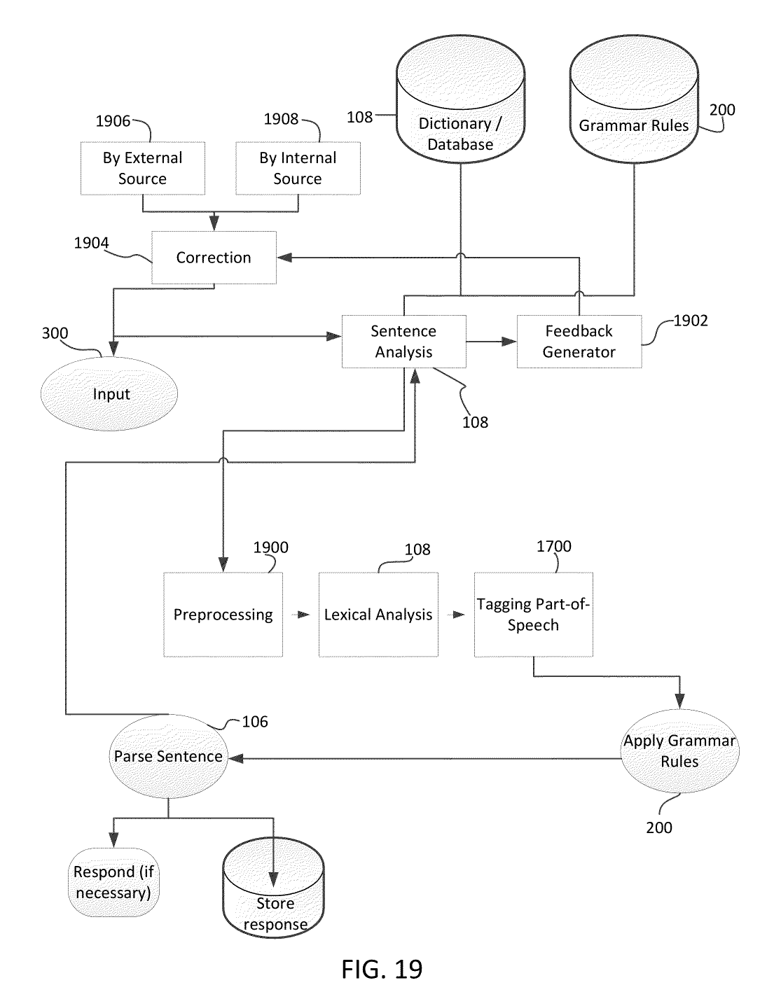

FIG. 19 shows a diagrammatic flow chart for generic language processing.

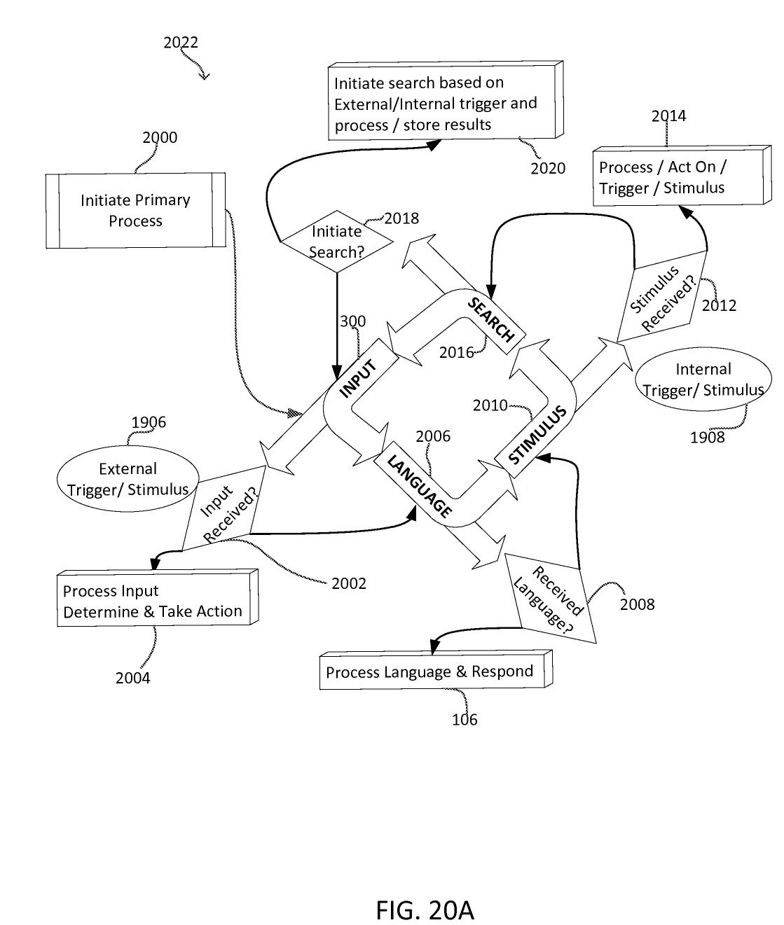

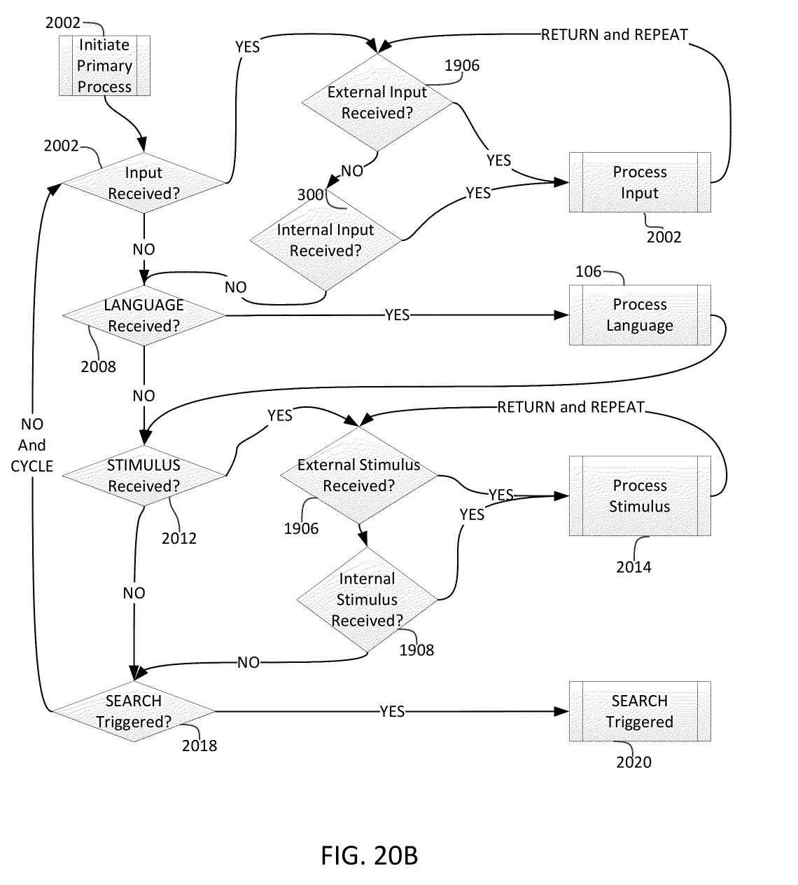

FIG. 20A and FIG. 20B show charts for core processing in different formats.

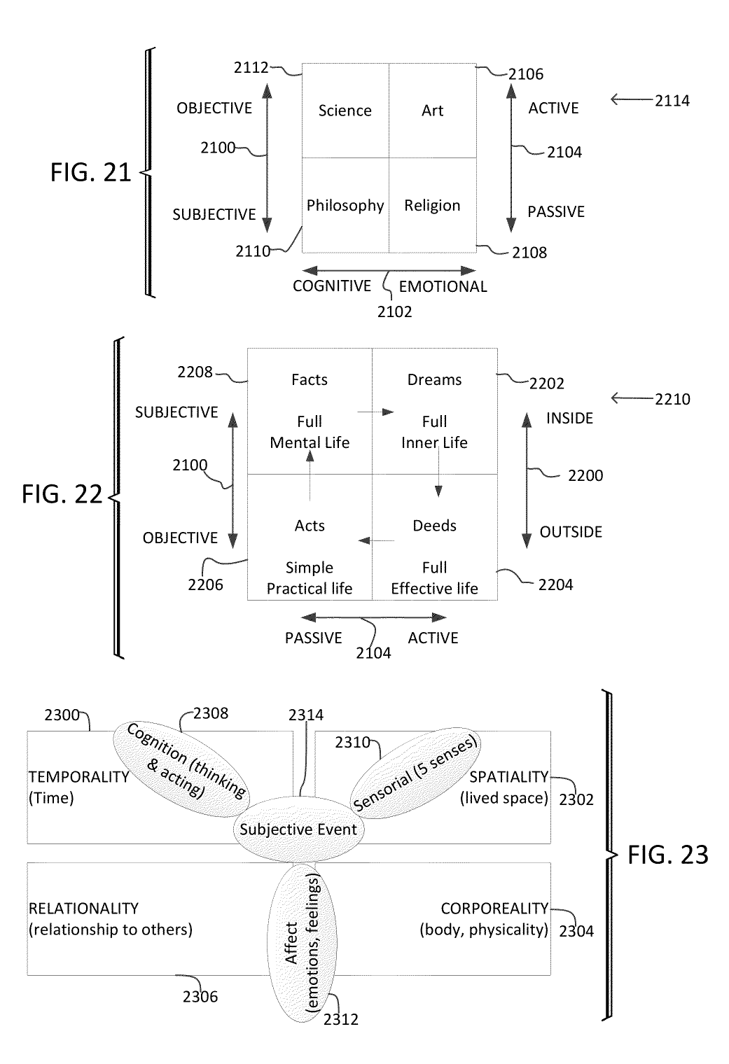

FIG. 21 shows a diagram of the cognitive and emotional connections and their levels.

FIG. 22 shows a diagram of Geddes' “notation of life.”

FIG. 23 shows the encompassing details of what defines a “subjective” event.

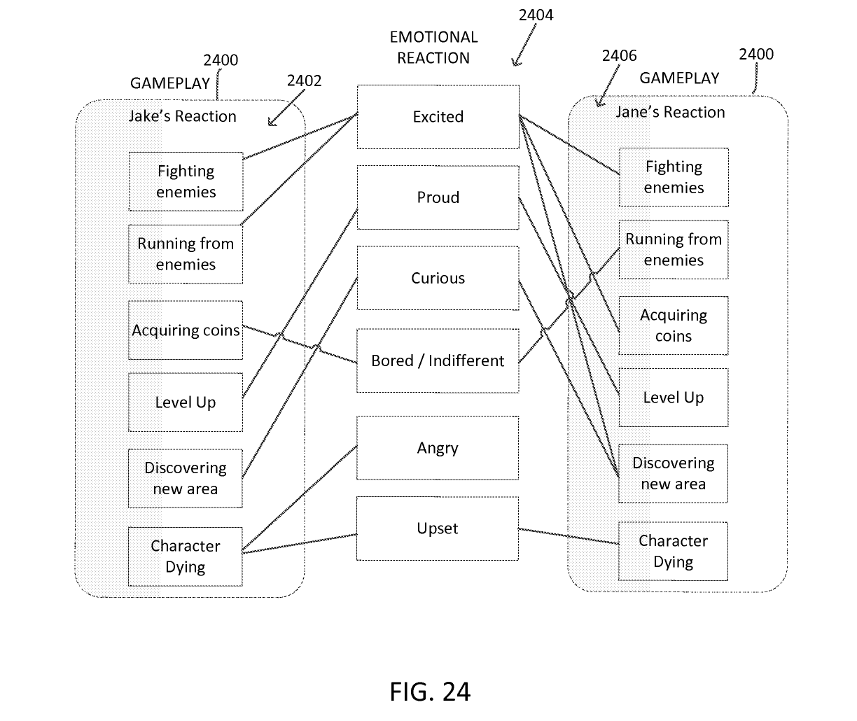

FIG. 24 shows two separate people's emotional reactions to the same game play.

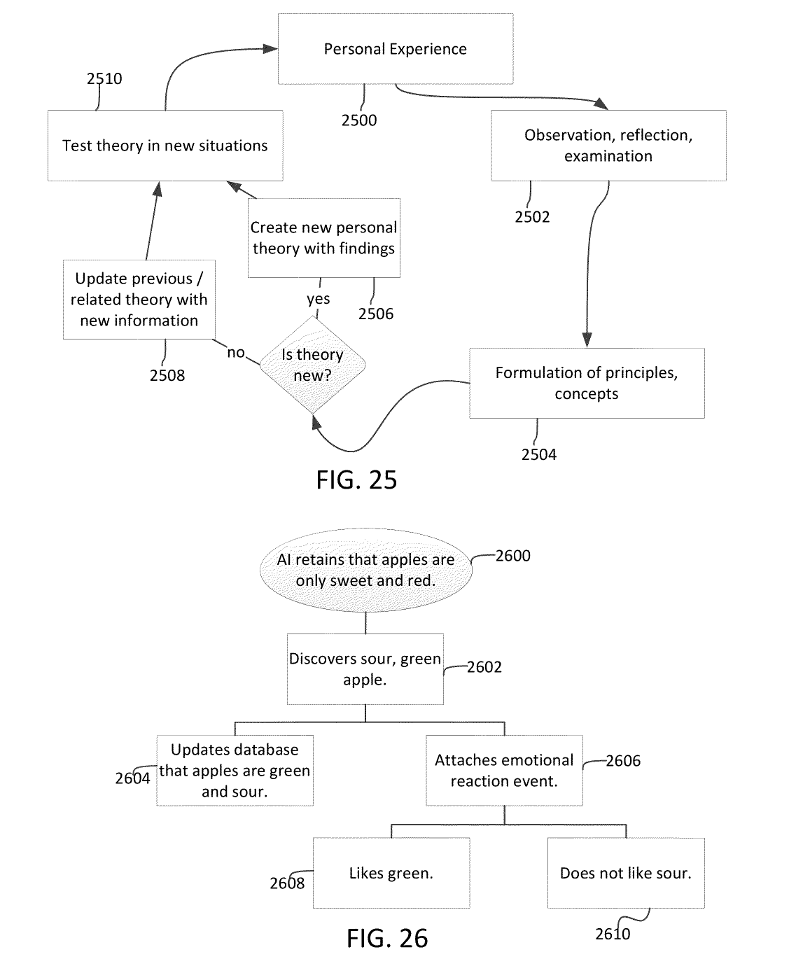

FIG. 25 shows a cyclic diagram illustrating formulating new principles or updating old ones based upon personal experiences.

FIG. 26 shows a flow chart diagram example of the artificial intelligence creating emotional reactions to subjective or personal experiences.

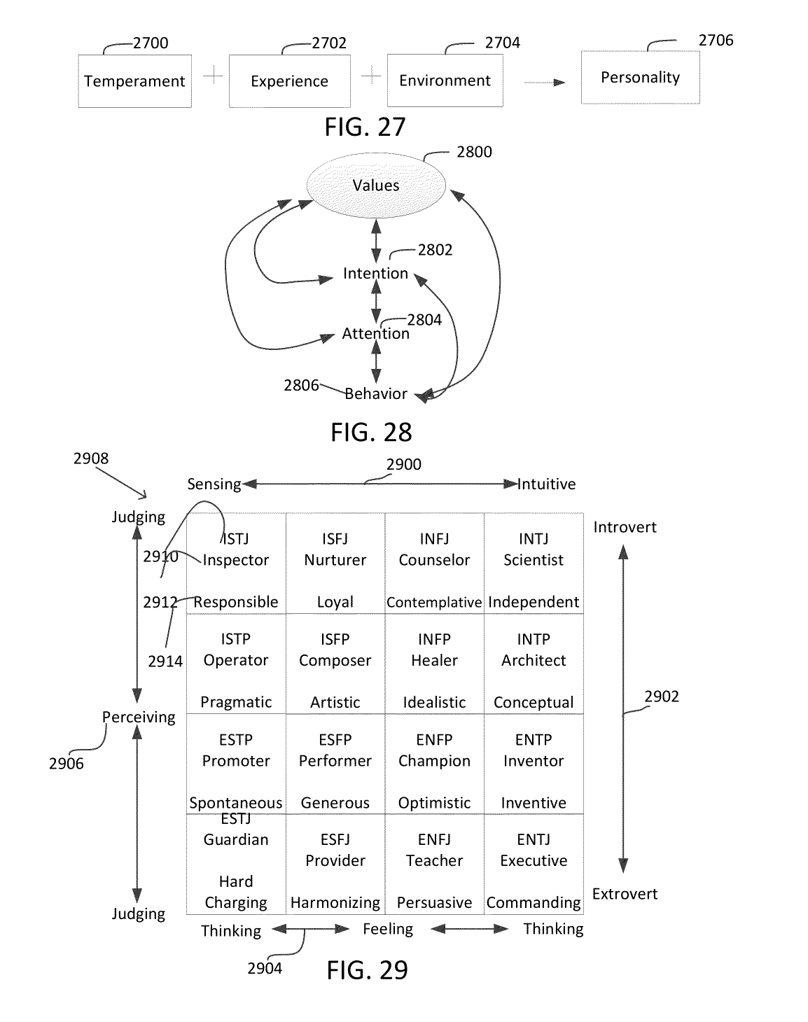

FIG. 27 shows a block chart that lists factors that create a personality.

FIG. 28 shows a diagram of how values affect intention, attention, and response behavior.

FIG. 29 shows a diagram of the current MBTI (Myers Briggs Type Indicator) for understanding normal personality differences.

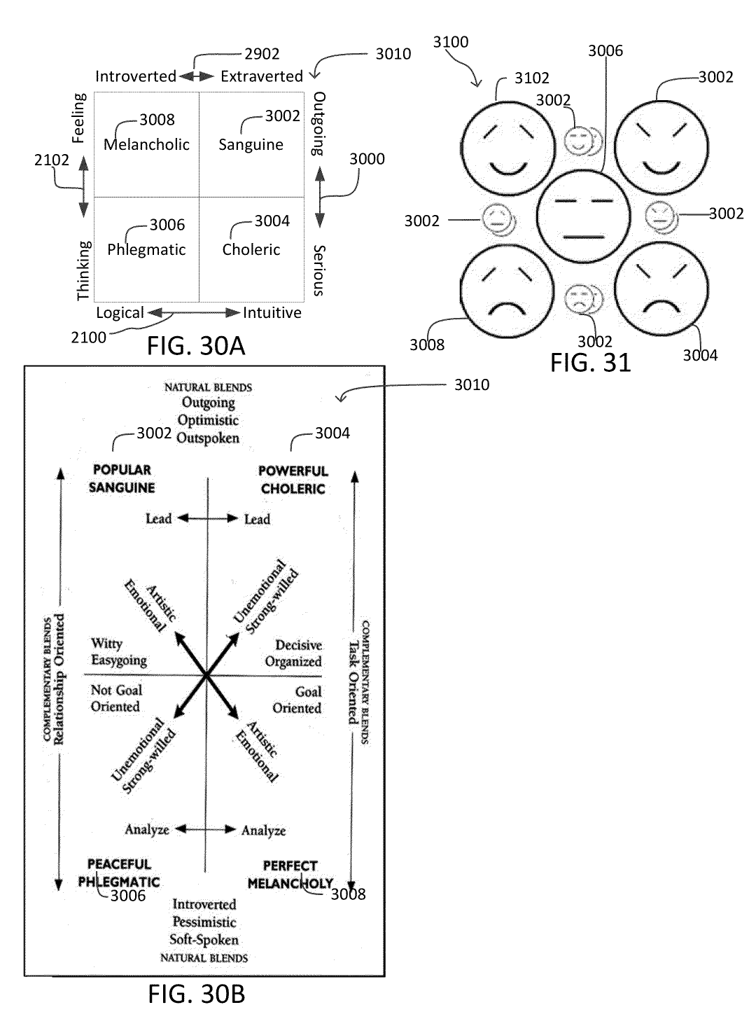

FIG. 30A and FIG. 30B show two different styles of personality types.

FIG. 31 shows faces of the classic Four Temperaments and the new Five Temperaments.

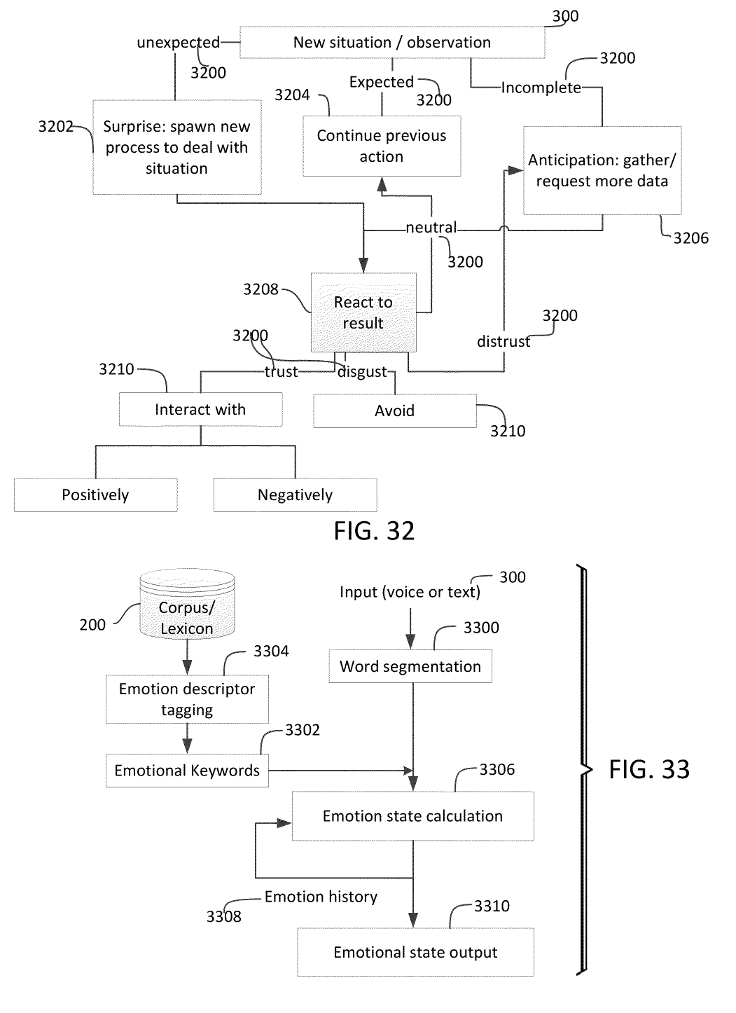

FIG. 32 shows a flow chart diagram illustration on reacting to a new (unexpected) or old (expected) situation or observation.

FIG. 33 shows a flow chart diagram illustration for emotional state recognition.

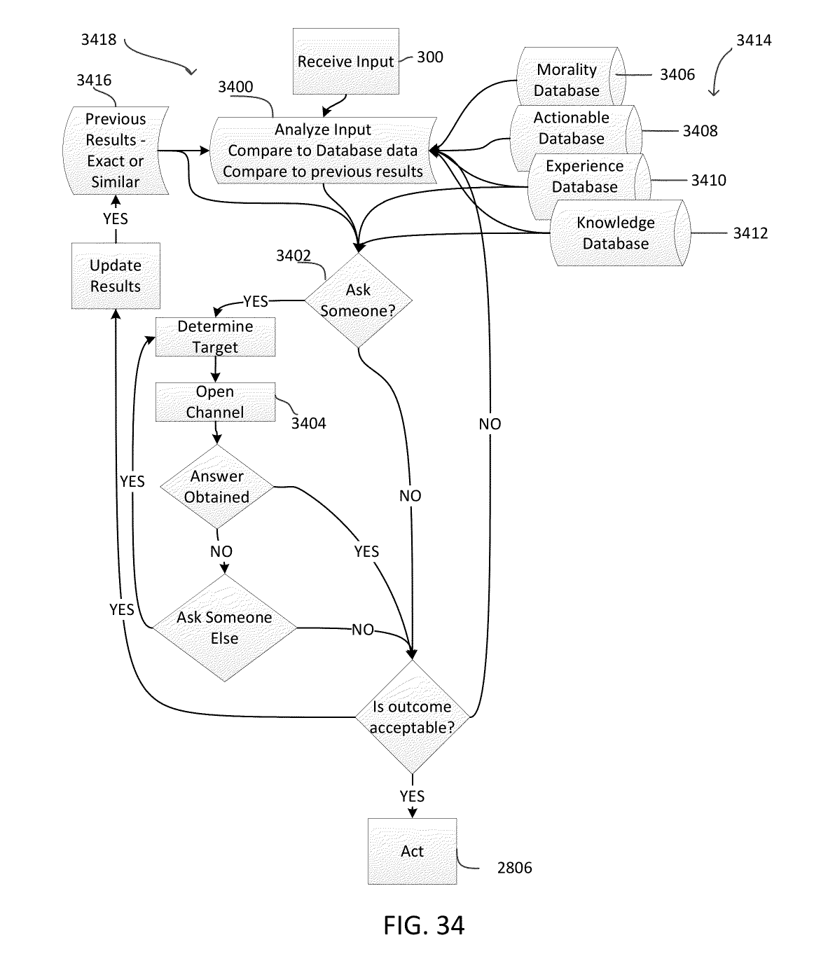

FIG. 34 shows a flow chart diagram illustration for sapience.

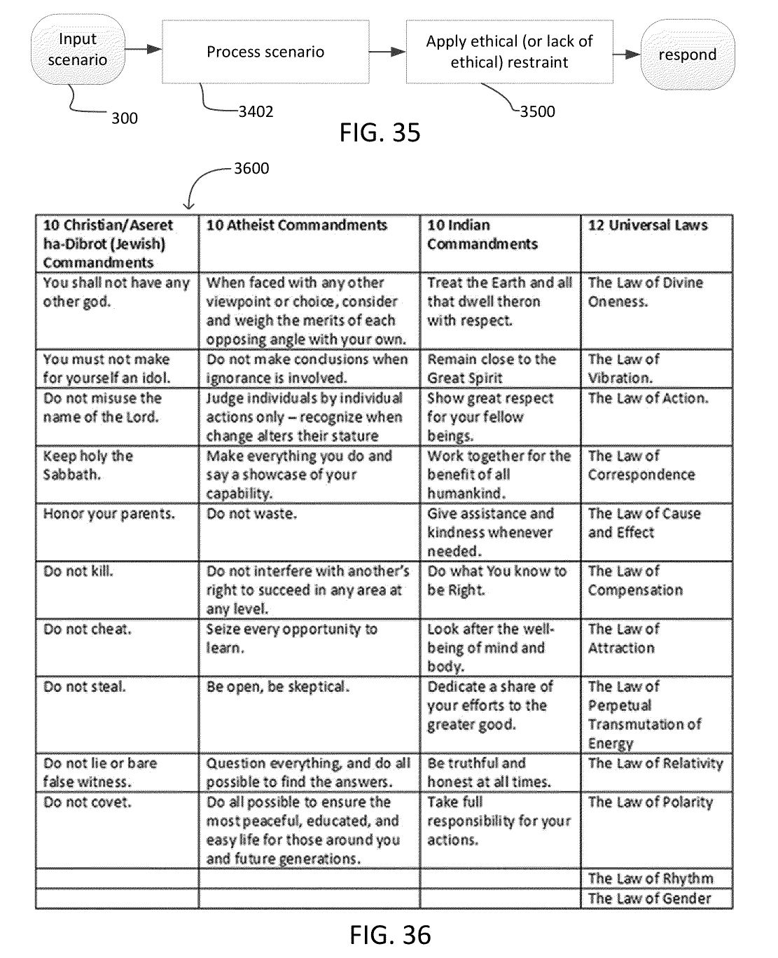

FIG. 35 shows a flow chart diagram, illustrating on applying decisions with ethical or lack of ethical system in place.

FIG. 36 shows a table of universal laws according to four (4) different belief systems.

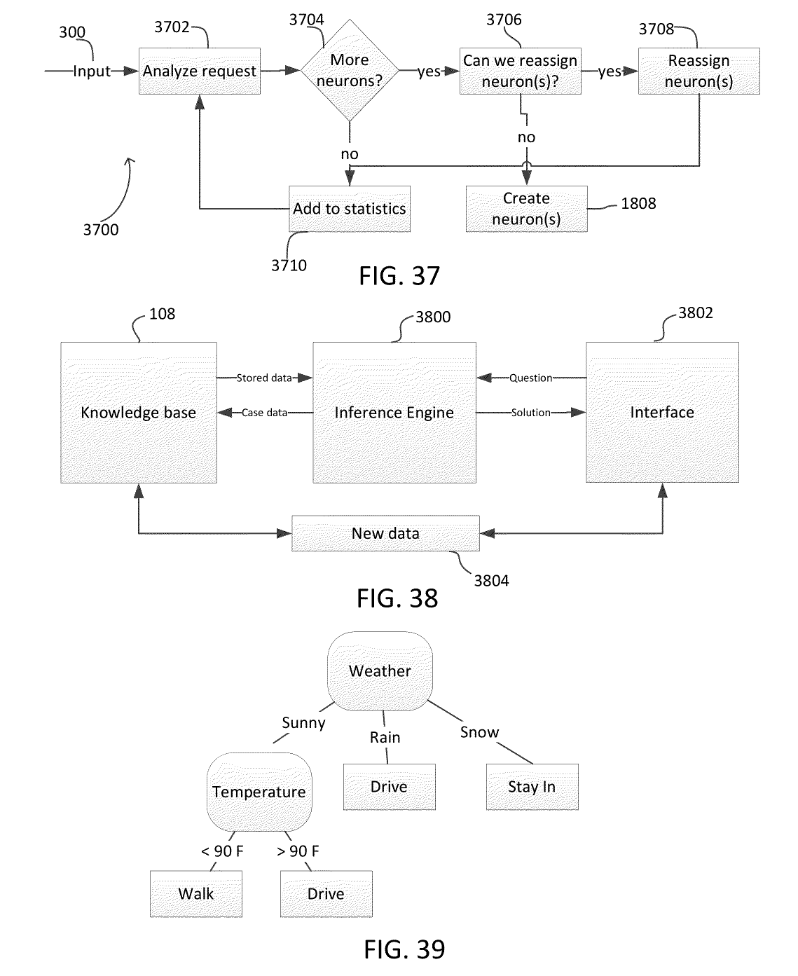

FIG. 37 shows a diagram of an archon.

FIG. 38 shows the basic architecture of an adaptable expert system.

FIG. 39 shows a primitive expert system on whether to walk, drive, or stay in.

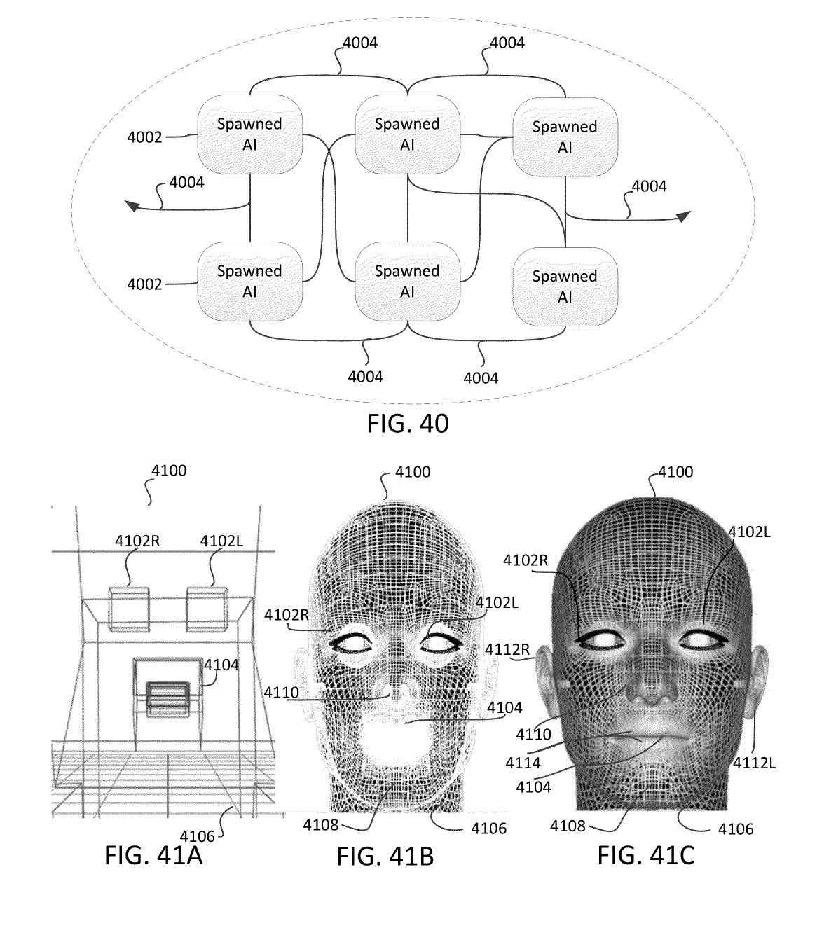

FIG. 40 shows a diagram of an AI cluster.

FIG. 41A to FIG. 41C shows the progression of the facial recognition.

### REFERENCE NUMERALS

| | |
|---|---|
| 100 | external source voice input |
| 102 | input/output control |
| 104 | speech recognition and analysis module |
| 106 | natural language processing |
| 108 | expert system database |
| 110 | language generation module |
| 112 | speech synthesis module |
| 200 | corpus/vocabulary and/or grammar rules dictionary module |
| 202 | semantic rules |
| 204 | pronunciation rules |
| 206 | speech or voice output |
| 300 | textual or verbal input |
| 302 | letter-to-sound conversion |
| 304 | speech dictionary database |
| 306 | speech unit language selection to convert to speech |
| 400 | input speech |
| 402 | sound-to-letter conversion |
| 404 | output text |
| 500 | artificial intelligence |
| 502 | methods for accessing core data storage database |
| 504 | methods for accessing the data warehouse database |
| 506 | storage database for all data |
| 508 | storage database for all core data |
| 600 | nucleus |
| 602 | soma or cell body |
| 604 | axon |
| 606 | dendrites |
| 608 | terminal buttons |
| 700 | neural network |
| 702 | comparing results |
| 704 | adjusting weights |
| 800 | neuron |
| 802 | generated output links |
| 900 | results parsed into smaller portions |
| 902 | weights |
| 904 | increasing importance of result |
| 1000 | neuron ready state |
| 1002 | neuron giving scheduling |
| 1004 | neuron running process |
| 1006 | neuron waiting for any inputs/outputs |
| 1008 | neuron in wait state |
| 1010 | input/output processing completed |
| 1012 | neuron timing out |
| 1014 | neuron process completed |
| 1100 | neuron suspending process |
| 1102 | neuron in ready wait state for next process |
| 1104 | neuron resuming process |
| 1106 | neuron sending dispatch to run process |
| 1108 | neuron in waiting suspended state |
| 1200 | diagrammed English sentence |
| 1300 | top-down sentence processing |
| 1302 | bottom-up sentence processing |
| 1304 | parsed English sentence in natural language processing |
| 1400 | systematic representation of BROCANTO |
| 1402 | word class nodes for BROCANTO |
| 1404 | valid transitions between nodes |
| 1500 | English sample sentence |
| 1502 | converting or translating between languages and |
| | their equivalents |
| 1504 | 1500 in binary |
| 1506 | 1500 in Hindi |
| 1508 | 1500 in French |
| 1510 | sample English sentence and other language equivalents |
| 1600 | Sample French sentence |
| 1602 | 1600 in hexadecimal |
| 1604 | 1600 in Polish |
| 1608 | 1600 in English |
| 1610 | sample sentences and their equivalents |
| 1700 | tagging feature for multiple languages |
| 1800 | find free neuron process |
| 1802 | check if neuron has space available |
| 1804 | archon process module |
| 1806 | modify neuron internals |
| 1808 | archon process for creating new neuron |
| 1810 | subject of conversation processing module |
| 1812 | subject/topic creation and storage |
| 1814 | apply topic as default for conversation |
| 1816 | ensure topic is known - link to overseer |
| 1900 | preprocessing of sentence |
| 1902 | feedback generator for sentence quality |
| 1904 | correcting feedback or sentence |
| 1906 | external source |
| 1908 | internal source |
| 2000 | initiate primary process |
| 2002 | verify input received |
| 2004 | process and take action |
| 2006 | language module |
| 2008 | verify language received |
| 2010 | stimulus module |
| 2012 | verify stimulus received |
| 2014 | process and take action on stimulus |
| 2016 | search module |
| 2018 | verify search initiation required |
| 2020 | initiate search |
| 2022 | first layer environment |
| 2100 | objective-subjective scale |
| 2102 | cognitive-emotional scale |
| 2104 | active-passive scale |
| 2106 | art |
| 2108 | religion |
| 2110 | philosophy |
| 2112 | science |
| 2114 | cognitive and emotional connections diagram |
| 2200 | internal-external scale |
| 2202 | dreams |
| 2204 | deeds |
| 2206 | acts |
| 2208 | facts |
| 2210 | Notation of Life diagram |
| 2300 | temporality, or time |
| 2302 | spatiality, or lived space |
| 2304 | corporeality, or physical body |
| 2306 | relationality, or relationship to others |
| 2308 | cognition |
| 2310 | sensorial, or 5 senses |
| 2312 | affect, or emotions or feelings |
| 2314 | subjective event |
| 2400 | gameplay scenario |
| 2402 | different scenarios within gameplay |
| 2404 | Jake's reaction go gameplay 2402 |
| 2406 | Jane's reaction to gameplay 2404 |
| 2500 | personal experience |
| 2502 | observation to personal experience |
| 2504 | formulate principles |
| 2506 | create new personal theory |
| 2508 | update related theory with new information |
| 2510 | test theory in new situations |
| 2600 | AI sample situation |
| 2602 | AI discovers alternation to situation |
| 2604 | update database with new conditions |
| 2606 | adds emotional reaction to event 2602 |
| 2608 | adds new condition 1 |
| 2610 | adds new condition 2 |
| 2700 | temperament |
| 2702 | experience |
| 2704 | environment |
| 2706 | personality |
| 2800 | values |
| 2802 | intention |
| 2804 | attention |
| 2806 | behavior |
| 2900 | sensing-intuitive scale |
| 2902 | introvert-extravert scale |
| 2904 | feeling-thinking scale |
| 2906 | perceiving-judging scale |
| 2908 | Myers Briggs Type Indicator (MBTI) |
| 2910 | MBTI personality type |
| 2912 | most prominent job/career |
| 2914 | most prominent personality trait |
| 3000 | outgoing-serious scale |
| 3002 | sanguine |
| 3004 | choleric |
| 3006 | phlegmatic |
| 3008 | melancholic |
| 3010 | personality-temperament diagram |
| 3100 | temperament group |
| 3102 | supine |
| 3104 | temperament blend |
| 3200 | reaction types |
| 3202 | surprise reaction |
| 3204 | continue previous action |
| 3206 | anticipation reaction |
| 3208 | reaction to result |
| 3210 | possible reaction to result 3208 |
| 3300 | word segmentation |
| 3302 | emotion/emotional keywords |
| 3304 | emotion descriptor tagging |
| 3306 | calculate emotional state |
| 3308 | emotional and emotion history |
| 3310 | emotional state output |
| 3400 | processing scenario |
| 3400 | request assistance |
| 3402 | determine user for assistance |
| 3404 | open channel for user to assist |
| 3406 | morality database |
| 3408 | actionable database |
| 3410 | experience database |
| 3412 | knowledge database |
| 3414 | collection of some databases |
| 3416 | check for previous results |
| 3418 | sapience/wisdom |
| 3500 | apply ethical constraint (or lack of) to situation |
| 3600 | universal laws table for 4 popular ethical or religious beliefs |
| 3700 | archon |
| 3702 | process input request |
| 3704 | neuron request module |
| 3706 | check available neuron module |
| 3708 | reassign neuron module |
| 3710 | add information to statistics |
| 3800 | inference engine |
| 3802 | user interface |
| 3804 | new data |
| 4000 | AI cluster |
| 4002 | singular AI |
| 4004 | connection/interaction between AIs |
| 4100 | head outline |
| 4102L | left eye |
| 4102R | right eye |
| 4104 | mouth |
| 4106 | neck |
| 4108 | chin |
| 4110 | nose |
| 4112L | left ears |
| 4112R | right ear |
| 4114 | lips |

### DETAILED DESCRIPTION

### Core Processing

Referring now to FIG. 5 which shows a basic database layout for core processing. All data can be stored within the neuron itself (within the neuron template, nucleus, etc.). Database data storage is one of the alternatives if the neurons and neural network can no longer contain or maintain the stability of the data within the core structure. Database data can also be used if the AI decides that the data is more efficiently stored within the database rather than the neuron blueprint. The neuron and neuron template is described in detail below. Other alternatives to storage include flat files, raw binary, etc. As such, FIG. 5 can be used to implement said alternative storage methods. The AI can store the data separately with multiple databases, one for core data storage 502 and one for the data warehouse 504. The core data storage 502 has the databases related to core data processing for the AI. This includes, but is not limited to, the language database, language rules, emotions, reasoning, and other core processes. Each of these can be created as separate databases so as to not pollute the data and integrity of other related data. The core data storage is vital information and data.

The data warehouse 504 stores all information not directly required by the AI's primary processing matrix 506. These are necessary but not vital processes, such as search (spider or crawler).

Referring now to FIG. 6 which shows a neuron as it is in the physical human body. A neuron is a specialized nerve cell that is the basic building block of the nervous system. Unlike any other cell in the body, neurons are specialized to transmit information throughout the body—between itself and other cells as well. A typical neuron is divided into three parts: cell body (soma) 602, dendrites 606, and axon 604. Each neuron also has a nucleus 600.

Neurons process and transmit information through electrical and chemical signals. These signals travel down the axon 604, into the dendrites 606. The signals from other neurons are received by the soma 602 from the joined dendrites and are passed on. The soma 602 and the nucleus 600 do not play an active role in the transmission of the signals. The two structures serve to maintain and keep the neuron functional.

Dendrites 606 are treelike extensions at the beginning of the neuron, and are covered with synapses. The synapses receive information from other neurons, and then transmit the electrical simulation to the soma 602. The synapse connects between the axon of one neuron and a dendrite or soma of another neuron.

The axon 604 extends from the cell body to the terminal endings. It transmits the neural signal to the neurons that the original neuron is connected to. The larger the axon, the faster it transmits the chemical and electrical signals.

The terminal buttons 608 are located at the end of the neuron. They send the signal from the beginning of the neuron to other neurons. At the end of the terminal button is a gap called a synapse. Neurotransmitters are used to carry the signal across the synapse to other neurons.

In the human body, neurons stop reproducing shortly after birth. Neurons die but are not replaced; however, new connections between neurons form throughout life. Unlike the human body, the AI has the ability to create new neurons as it sees necessary. The ability to create new neurons is described in detail in the archon below (FIG. 37).

Referring now to FIG. 7, it is an illustration of a simplified neural network diagram for achieving expected results by adjusting the weights of the result. When an input 300 is received, the neural network 700, which is a combination of many neurons 800 linked together with input 300 and output 802 links, compares the results 702 between the actual results and what was the desire result. The desired result is what the AI claims to be the result, versus the actual result of what should be. Comparing the results, the neurons adjust the priority or importance (weights 704) of the result within the network. For example, the AI receives an incorrect input that two plus two is five. It has been taught that two plus two is four. When the equation is sent into the neural network 700, links are created for the new data that two plus two can possibly equal four. The information is compared 702—four (actual result) versus five (desired result)—and the AI learns that the initial input of four is incorrect. The neurons that created the link between the incorrect statements adjust the weight values 704 by depreciating the weight to the incorrect link. The neural network is up-to-date with the correct information, limiting or severing weights or connections to incorrect data or results, and promoting or increasing weights to correct results.

Referring now to FIG. 8, a simplified neuron 800 illustration with incoming and outgoing links. The incoming connections 300 or outgoing links 802 formed between neurons create structures called neural networks. Each neuron can have many incoming and outgoing connections between its' dendrites 606. Incoming connections 300 are from other neurons making requests to that specific neuron. Outgoing connections 802 are connections that the specific neuron believes will heighten the strength or give priority between the input requests. For example, if the AI drinks coffee every day at 8 AM, then the input 300 (coffee) tells the time-specified neuron (800) to create strong weights to the outgoing links (802) for time, coffee, and the resulting feeling. Over time, the neurons start to react that at 8 AM, the AI must drink coffee or else side effects may occur (irritability, anxiousness, etc). If the AI drinks coffee sporadically, the incoming connection and weights between neurons is much less. Thus, the likelihood of side effects when the AI does not drink coffee at 8 AM is much less, if any at all.

Referring now to FIG. 9 which shows a neural network diagram and applying weights to achieve a certain result. Data 300 is received, and sent into the neural network for processing. The first layer has input neurons or nodes 900. The input neurons 900 (node 0, 1, 2) send data via synapses to the second layer of neurons (3, 4). The neurons decide the priority of the request by weights 902. The weights 902 are the stored parameters within the synapses that manipulate the data in the connections. Once priority is established—if the request was made previously, etc.—then the link to the final neuron (5) is made. The weight of the request is increased again 904 to show that the request is being prioritized.

The more vital or important input data is, the more weight increase the result will have. For example, if the AI is searching for data on the internet and it is interrupted by a user around 9 PM every day. The neurons will increase weight to searching data before and after 9 PM, or more importance after the interrupting user has left the conversation.

Referring now to FIG. 10, a diagram of a neuron's nucleus with simple processing and wait capabilities. Receiving an input 300 that may or may not have been processed, the neuron 800 is in a ready state 1000. The ready state 1000 is the ability to create tasks based upon the input or have the tasks being given with the input. The input is given scheduling 1002, either low-level or high-level scheduling. This prioritizes whether the input needs to be processed immediately or can be postponed for a few cycles. Once scheduled, the processing runs 1004. If the process does not require any other input or output, the process ends 1014. If the process takes too long, it can timeout 1012, in which case, the neuron is set back to ready for processing 1000. If there is an input or output required for finishing the process 1006, the neuron is set to a wait state 1008. In the wait state 1008, the neuron waits for any additional information or processing required completing the process. Once the input or output is completed 1010 or received, the neuron is ready 1000 to process, scheduled 1002, and runs 1004 the process. It is finally completed 1014.

Referring now to FIG. 11, it is the evolution of FIG. 10 where the neuron nucleus now has advance processing and wait capabilities. Until and once an input 300 is received, the neuron 800 is in a ready state 1000. The input is sent to dispatch 1106 which begins the running 1004 process. If there is nothing left to process, the process is completed 1014. If there is an input required for completion, the neuron is sent to a wait state 1008 as it waits for the input or output 1006. If the input or output is received 1010, then the neuron is set to ready 1000 and goes through the processing cycle again. If the neuron is still waiting, it can stay in a suspended state 1108 by triggering the suspend request 1100. Once the input or output is received 1010, then the neuron is moved to ready suspended state 1102 if necessary. It can resume 1104 processing once being set into a ready state 1000. At any time the processing can be suspended 1104 if more information or input is necessary for the completion of the process.

The neuron nucleus can evolve depending on many factors, including, but not limited to, how frequently it is being requested to process data, how many connections to other neurons it has, how long the axon is, etc.

Referring now to FIG. 20A and FIG. 20B, this is the management system. This system runs above the core system: it continually checks for “interruptions”, and then spawns another process to deal with said interruption. In this, the core can continue processing the required tasks necessary for the continuation and evolvement of the AI without having to deal with unnecessary interruptions.

The primary process 2000 can be input, language, search, or other stimulus. Once the primary process is initiated 2000, the system checks if it is input 300, language 2006, stimulus 2010, or search 2016. In all cases, the system spawns processes to deal with the interruption while continuing checking. Checking does not ever stop.

If the interruption is an input 300, the system checks if the input is external 1906 or internal input 300. If it is either external input 1906 or internal input 300, the system processes said input 2002 (language processing, etc.) If the primary process 2002 is language 2008, then the language is processed 206 (language processing, grammatical, analysis, etc.) If the process is a stimulus that was received 2012, if an external stimulus received 1906 (smells, loud noise, etc.) or an internal stimulus received 1908 (neuron short-circuits, etc.), the stimulus is processed 2014. If the process is a search 2018 (a user wants to know how many people live in China, what is the speed velocity of a swallow), then the crawler is initiated and the search is triggered 2020. All processes are completed and returned to continually checking for more interruptions.

Referring now to FIG. 37, the flowchart describes a specific neuron 800 type: the archon 3700. Unlike the human mind, which has no management neurons, the archon 3700 is able to process requests from other neurons to create more neurons 1808 or reassign neurons 3708. The archon also keeps a detailed inventory of each request, and the result of each request: did the archon successfully reassign neurons or was it forced to create neurons, and why.

When the archon 3700 receives a request 3702 for more neurons due to under capacity for a current task, the archon 3700 evaluates 3704 if the need for more neurons is valid. It evaluates the process 3704 by looking at its' statistical inventory 3710: how many neurons are assigned to that task, what is causing the overload, and other relevant vital information to create a decision. If the archon 3700 decides that no neurons are needed, it adds to the inventory that the process was denied and for what reason. If the archon 3700 decides that the request is valid, then it checks its' inventory to see if any neuron or neurons can be reassigned from other processes 3706. If there are no free neurons capable of being reassigned from within the current archon's sector, the archon 3700 can send out a request to other archons to see if there are any available neurons for reassignment. If another archon 3700 responds that there are neurons 800 that are currently available for reassignment, the tagged neurons 700 create links 902 the requesting archon's neurons, and are temporarily reassigned. The archon 3700 adds the result—which neurons 800 were reassigned from what group—to the inventory list. Once the process is finished, the neuron links 902 can be terminated by the neurons or let die on their own. The termination allows the transferred neurons to resume working within the scope that they were originally built for (e.g., neurons that originally aided in learning multiple languages ruin the connection between less-used languages, allowing the mind to forget the less-used languages).

If other archons do not respond to the initial archon request for neuron reassignment, the archon 3700 can trigger a reaction to create more neurons 1808. Once the process is complete, the neurons 1808 are assigned to the request. Once the request is completed, the neurons 1808 can be integrated within the area of the process so that the likelihood of under capacity does not occur again. Otherwise, the neurons 1808 can be assigned to another process that requires more assistance.

Referring now to FIG. 40, the AI has the ability to spawn sub-routines 4002 or create clones 4002 of itself for a specific purpose. These clones 4002 are able to interact with each other 4004 using temporary gateways for the duration of the exercise, becoming groups or clusters for the purpose of that exercise. For example, a core AI may spawn off sub-unit AIs 4002 in the battlefield in attempts to control unmanned vehicles or integrate itself into enemy telecommunications. The spawned AIs 4002 can be destroyed once the exercise is completed, assimilated, modified, or reintegrated to be used for another exercise, internal processing, other task completions, or whatever the AI or the commanding expert deems necessary.

The gateways 4004 may be a single neural connection that fires off commands from one clone 4002 to the next; or it may be a complete integrated LAN network that the officers set up.

### Voice Recognition and Response

Referring to FIG. 1, the flow chart describes the architecture of a spoken phone dialogue system. This is a very basic flow chart, as it only describes one-way input, that is, only a user speaks 100 with generic or pre-determined voice responses. This example is used to illustrate the architecture, as FIG. 2 shows how the dialogue system can be enhanced to have the AI respond as well, which will be described below in detail. A user speaks 100 into a device, such as a telephone or microphone, and over the network 102, the voice is received and recognized 104. The speech 100 undergoes analysis and language processing 106. During processing 106, the AI determines what language is being spoken, perhaps what accent, and other nuances all within the database 108. Within the database 108, the AI also determines what proper response should be given. Once a response is established, the AI begins language generation 110 to respond. The text is synthesized into a voice using the speech synthesis 112 module. The result is sent over the network interface 102 and the user hears the response. For example, a user calls 100 asking for technical support, that the server is not responding to pings across the network. The user's input is sent down the network interface 102, and the AI recognizes that the user is speaking in a southern American English voice using the speech recognition 104. The sentence undergoes processing 106—what is a server, what is a ping, what is a network, etc.,—and the expert system database 108 attempts to figure out the cause. It goes and attempts to ping the network that the server is on, the network responds. It pings the server, the server responds. The AI knows that the since the server responds over the network, then the issue is not the power but most likely the firewall settings. The AI formulates a response 110 then sends it for speech synthesis 112. Once the speech is synthesized, the response is sent over the network 102 to the user, and the user hears the response.

Referring now to FIG. 2, the flowchart is an enhancement to FIG. 1, where the AI can process a voice output 206 without the need for predetermined phrases or sentences, as in a generic expert system. When a user speaks to the AI 100, the AI recognizes (“hears”) that it is being spoken to. Much like FIG. 1, it recognizes the speech 104—language, accents, other nuances, etc., all within the dictionary 200—and beings parsing the request 106. It may need to look up words it does not understand or has no previous definition for using the dictionary 200. The voice input is processed 106, with the semantic rules 202 (which includes grammar, sentence structure, etc.) being applied to the input 106. Once the language processing 106 is complete, the processed sentence is interpreted by the expert system 108. The expert system, 108, is one of the main components of the AI. Once the expert system 108 compiles an answer, it generates a response in the appropriate language 110 using the correct pronunciation rules 204 of the language. In other words, the AI knows that if spoken in Polish, “i” is pronounced as “ee” and “e” is pronounced as “eh”; if spoken in English, “i” is pronounced as “eye” and “e” is pronounced as “ee” or long e. The speech is synthesized 112 with the appropriate tone and language. Once synthesized, the response is given in the form of a voice or vocal output 206. Using this method, the AI can easily make phone calls without the need for first calling it. It also enables the AI to process and instigate requests, rather than waiting on the request to be made to it. For example, if your vehicle is in the body shop, the AI could call on the mechanic's behalf that your vehicle is ready for you to take home. Going further, with an adept expert system 108, the AI could help the mechanic with the fixing and maintenance of your vehicle. Once the maintenance is completely, it can immediately call you without needing the mechanic to tell it to call. Alternatively, the AI can ask permission from the mechanic to call, or the mechanic can tell the AI to call.

Referring now to FIG. 3, the flowchart describes specifically the conversion from text-to-speech, or textual input to verbal response. When there is a textual input 300, the text analysis module within the expert system 108 converges with the dictionary 200 and the text-to-sound conversion 302. The letter-to-sound conversion module 302 works with the dictionary 200 to analyze what the input 300 is, and a proper response to said input 300. Once the text analysis module 108 is complete, the speech dictionary 304 is triggered. The speech dictionary 304 combines the text response with the text or words used in response 306. The response is then synthesized 112 with a speech synthesis module 112 to create a speech response 206. In this case, the AI is able to create a verbal response if a user creates a textual input, if it is reading something out loud, or other situations that would require text-to-speech conversion.

Referring now to FIG. 4, which is a block flow chart for converting speech-to-text. Much like FIG. 3, where the conversion was text-to-speech, the AI has the ability to convert speech-to-text. This is an ability it can use when working with dictation (for example, writing emails as it is orally given direction; or if a user does not understand or is incapable of writing). When a speech input 400 is given, the speech analysis module 104 works with the speech database 304 to choose the correct text or written word 306 for a textual output 404. Using the dictionary 304, the sound-to-letter conversion 402 is made to convert the sounds made in speech 400 to a textual output 404.

### Language Processing & Diagramming Sentences

Referring now to FIGS. 12 and 13, the illustrations show a simple diagrammed sample English sentence, “Does this flight include meals?” “Does” is an auxiliary word, “this” and “a” are determiners, “flight” is a noun, “include” is a verb, and “meal” is a nominal word. FIG. 12 uses a standard sentence diagramming technique in figuring out what are the parts of the sentence 1200. FIG. 13 uses a more advance method called top-down processing 1300 or bottoms-up processing 1302 for processing the sentence 1304.

Top-down processing 1300 is a parsing strategy where the system first looks at the highest level of the tree and works down the tree by using the rules of grammar. Top-down is stereotypically viewed as the person who sees the larger picture rather than the details. Bottom-up processing 1302 looks at the lowest-level small details of the tree before going up the tree. This leaves the highest-level overall structure last for processing. Bottom-up is generally considered to be a person who focuses on the details rather than the larger picture. Regardless of the method, the AI has the ability to choose between both and other formats for processing sentence structure.

Referring now to FIG. 14, the diagram is a schematic representation of the artificial grammar of BROCANTO. BROCANTO is based on the universal principles of natural languages (i.e., it consists of different syntactic word categories and defined phrase structure rules). The nodes 1404 specify word classes (such as nouns, verbs, etc.). The arrows 1402 indicate valid transitions between nodes. Every sequence of transitions from the beginning node 1404 ([) to the end node 1404 (]) constitutes a well-formed sentence. The use of BROCANTO highlights the AI's ability to use artificial languages, not just BROCANTO but lojban, among others, as well as natural human languages to learn by itself, with others, and interact with users.

Referring now to FIG. 15 and FIG. 16, both of these figures show a cyclical graph of translating between sample languages and other language equivalents 1502. Each language can be converted 1502 regardless of the input language. The initial input language is irrelevant, as the AI is built to learn and understand both natural (human) languages, such as English 1500, Hindi 1506, French 1508, Polish 1608, or non-human (constructed) languages such as binary 1504 or hexadecimal 1602. It is able to convert to a language it prefers, be it English, binary, or a completely new language, or translate between languages 1610 with ease. For example, a user can speak or type in French 1508 and the AI can respond in French 1600, or respond to a user in English 1606 if the language is undetermined (or the AI has not learnt it yet).

Referring now to FIG. 17, the illustration shows the tagging process for 3 very different sample languages: Bangla, English, and French. In each case, the sentence is broken apart to the words that make up said sentence. Each word is then “tagged” with the words' part-of-speech. In the example, “DT” is for Determiner, “VBZ” is for verb, “NN” is for noun, “SYM” is for symbol (such as comma or period), and “ADJ” is for adjective. The AI is able to tag languages both natural and constructed languages with a generic tagging processor. The processor can either tag words based on its' own available dictionary (which may have been given by an expert user, or it processed on its' own), or tag on-the-fly if no information is available by figuring out the sentence structure through lexical analysis 108.

Now referring now to FIG. 18, which shows a flow chart describing how to understand the topic or subject of the sentence or conversation. A user verbally or textually inputs 300 a word, sentence, phrase, paragraph or a whole speech. The system begins to look for a neuron 1800 for processing. Neurons can be any type of neuron that specializes in that processing—for example, if the user speaks, then neurons specializing in auditory translation will be recruited. The system checks if the neuron is free or able to actually process the user input 300.

If the system discovers a free neuron or set of neurons, the neuron takes the user input and begins signaling other neurons within the scope to help with processing 900. It then proceeds to language processing 106, either auditory/verbal or textual or a combination thereof. The processing attempts to find the topic of the conversation. Sometimes, the topic is obvious 1810. For example, the user continually talks about different species of cats, or different car models. If the subject is obvious, then the AI checks to see if a related topic already exists in the neural network then in the database. Did the user or some other user already talk about the topic? If not, then it creates the new topic 1812 to be used for later or other users, and links the topic to the overseer 1816. The topic then becomes the default topic for the conversation 1814 or as a beginning/introductory topic for that same user or other users. If the topic does exist in the neural network or stored in the database, then the current topic is also linked to the overseer 1816, and the system continues to wait for continuing the conversation.

If the system cannot find any free neurons, it checks to see if they are out of capacity 1802. That is, if the neuron is doing low-level processing that can be temporarily postponed. If the processing can be postponed, then the archon is requested to find other similar neurons that are dealing with low-level processing 1804. The archon is described in detail in FIG. 37. If neurons were found, then the internal structure is modified 1806. The assumption is that if the neuron is only dealing with low-level processing, but high-level processing requires more power or help, then it is better to be slightly over capacity then under capacity. High-level processing neurons can always create links to low-level processes, or the archon can create more neurons to deal with low-level processes. Internal neuron modification can be considered modifying human DNA: trigger certain genes on or off to get different results. After the internals are modified, the neurons begin the verbal or textual language processing 106.

If the neurons are all out of capacity 1802 and no low-level neurons were found or capable of being transferred, the archon triggers the process to create new neurons 1808. The description of how the archon can create new neurons is described in FIG. 37.

Now referring now to FIG. 19, which shows a diagrammatic flow chart for generic language processing. Most expert systems or claims at artificial intelligence only deal with natural language processing—that is, human language. Only other systems, this diagram shows how the AI to process not only natural or human language, but to process artificial or non-human or other types of constructed language. At input 300, the sentence is sent for analysis with the sentence analysis module 108. The module deals with the grammar rules 200 to figure out what the sentence is describing; as well as a generic database or dictionary 108 for the sentence so that the AI knows the definition of each word of the input. The module takes apart the sentence during pre-processing 1900, sends the structure down for lexical analysis 108. Once the analysis is complete, each word is tagged with the part-of-speech 1700 that the word is (for example, “the” is labeled as DT or determiner; “house” is labeled as N or noun). Once the words are tagged, grammar rules are applied 200 (the word the subject of the sentence, what is the verb, etc.) Then the sentence is parsed 106 for other relevant data—is the sweater blue or grey, what is sweet, etc.

All data is stored in the database at the same time the sentence is parsed. The AI also responds to the input (for example, if the input is a question, such as “How are you?” or an incorrect, “The sky is purple.”) After analysis 108 is complete, the sentence is given feedback at how accurate the response was 1902. For example, if a user states the sky is purple and the AI concedes that the sky is purple, the feedback would be that the statement is incorrect. Correction 1904 is given by either the input user 1906, such as an expert user, which is an external source; or internally, by the AI itself through research 1908. Once the invalid input is corrected, the AI resumes waiting for the next input by the user.

### Sentience, Subjective Events, Emotions

Referring now to FIG. 21, shows a diagram of the cognitive and emotional connections and their levels. Generally, Science 2112 and Art 2106 are more objective on the objective-subjective scale 2100. If you have a scientific equation, you cannot interpret it in any other way except what the equation and its' result is. For art, while it can be argued that art is more subjective (especially when dealing with abstract art), you cannot argue that the painting is an oil painting on canvas, or that the artist painted a starry night. Both Science 2112 and Art 2106 are more active activities on the Active and Passive scale 2104. You cannot passively sit to the side and expect science or art to happen. You have to actively engage for anything to be produced.

On the other hand, Philosophy 2110 and Religion 2108 are more Passive 2104 and Subjective 2100. Philosophy 2110 and Religion 2108 can be both widely interpreted across generations, time, minutes, people of different cultures and faiths, and many other circumstances. Philosophy 2110 is more Cognitive 2102, however, on the cognitive-emotional scale 2102, as philosophy requires thinking and developing for suitable arguments, retorts, and methodologies. Religion 2108 is considered more emotional. While a user is not required to actively think within a religious context (aside from interpreting religious history), religion itself speaks to believers on an emotional level. Philosophy emphasizes the use of reason and critical thinking. Religion may make use of reason, but do require faith—or use faith at the exclusion of reason.

With the use of a diagram such as this, the AI can determine the difference between objectivity and subjectivity—whether its' thoughts are rational or irrational, thoughtful or emotional. While for humans it is a background process, the AI must be successful in arguing the points of subjectivity and objectivity, as well as do it reasonably. Discovering passion is the first step to acknowledging emotions and becoming self-aware.

Referring now to FIG. 22, which shows Geddes' Notation of Life diagram. All life requires and acts upon the four nodes within the notation diagram. All humans deal with Facts 2208, Dreams 2202, Deeds 2204, and Acts 2206. Furthermore, all these nodes are more subjective or objective, passive or active, and deal with either internal (mental) or external (social) implications.

Facts 2208 help define a full, mental life. Facts are entirely subjective—given a car accident, both sides will give their “facts” or statements of how the accident occurred (generally, it's the other person's fault). Even historical facts are subjective. Most notably is the controversy in Japan, where Japanese history textbooks attempted to whitewash the actions of the Empire of Japan during World War II, such as the Nanking Massacre. Regardless that the situation did occur, the Japanese government wanted to remove the entire occurrence from at least its' historical archives and facts. As such, facts can be interpreted, modified, and challenged very easily.

Dreams 2202 are also entire subjective as well as deal with the mental well-being of the entity. All dreams occur within the realm of a single entity internally, though the dream can be shared after the entity has awakened. Dreams are necessary for an entity's survival, as without sleeping and dreaming, one can go insane. Hence, Dreams lead to a much fuller inner life and contribute a stable mentality.

Deeds 2204 promote a much more full and effective life. Deeds are active actions that do require the entity to actually do something, be it positive or negative. A deed cannot be done statically, it requires active movement, and require social or outside interaction 2200. A deed can is interpreted more objectively 2204. A person saving a child from a burning building is objective: the person ran in and saved a child. Perhaps the child was the person's daughter, or perhaps the person had lost a child in a fire before years ago. The deed itself cannot be interpreted anything except for it is; the reasoning behind the deed can be subjectively interpreted.

Acts 2206 are also objective, allowing for an entity to have a simple, practical life. Acts are more passive, but do deal with external or social interactions as well, like deeds. However, acts are more frequent, whereas deeds are more heroic and less frequent. For example, another child standing up to a bully who pushed someone to the floor can be considered a heroic deed for that child. An act, perhaps out of kindness, is to help the child on the floor up.

Following the four nodes within the diagram not only can help humans but the AI itself to grow a much fuller and healthier existence. It is able to ask itself: how many acts or deeds have I done today? What facts of life am I looking for? Do I dream? Asking itself more philosophical or subjective questions allows it to mentally grow and create a spark within itself that will lead to sentience or consciousness.

Referring now to FIG. 23 which shows the encompassing details of what defines a “subjective” event. The subjective event 2314 is at the center of the model. It is created by the thinking and acting, or cognition, 2308, the 5 senses 2310, and the affect 2312, or the emotions or feelings, of the person having the subjective event. The cognition 2308 is related to the time 2300 it takes to think about or react to the subjective event. The 5 senses 2310 are limited to the spatiality 2302 or space around during the event, as well as the actual physical limitations or corporeality 2304. The affect 2312 is related to the relationality 2306 (relationship to others) and how their emotions or relationship affects us during the event; as well as our current physical limitations or corporeality 2304. All of these factor into the definition of a subject event.

Referring now to FIG. 25, a cyclic diagram illustrating formulating new principles or updating old ones based upon personal experiences. All life an existence itself is a personal or subjective experience 2500. Like humans, AI existence is a subjective experience. No human can think of being an AI and no AI can think of being human. A human can only think of being like an AI, and an AI can only think of being like a human. The emotions, experiences, and observations are entirely subjective; however, they may be similar and can relate. One person cannot go through exactly what someone else is going through, but they can undergo similar circumstances, provide empathy and relate with the other person. As such, personal experience 2500 is experienced through observation, reflection, and examination 2502 of said experience. The AI puts its' hand near a flame, and it burns its' metal finger. It may or may not feel pain, but melting any structure on itself is conceived as bad. Once the experience is examined, concepts and principles 2504 can be formed, depending on if the concepts deal with a new situation or an old one. If the AI was burnt before by fire, it can update a previous theory 2508 it had about fire that fire is shiny and bright. If the AI was not ever burnt by fire before, then it can create a new theory with the findings 2506 for itself.

Referring now to FIG. 26, it is an example of the AI creating emotional reactions to subjective or personal experiences. The AI knows only that apples are only sweet and red 2600. While processing information, it discovers also that there are not only red apples, but also green apples as well 2602. It does not know that green apples are sour initially, but does after taking a bite from a green apple. Once it takes a bite and discovers the sour green apple, it updates the information in the database 2604 that there are green colored apples and that they are sour. It also attaches the emotional reaction it had 2606 to eating a sour green colored apple: it retains that it likes the color green 2608 but does not like the sour taste 2610.

Referring now to FIG. 24, this figure shows two individuals, one male and one female, reacting to the same gameplay situations. It is apparent that despite playing the same game together at the same time and dealing with the exact situations within the game, Jake's reactions 2402 are often different than Jane's reactions 2406. For example, when Jake is fighting enemies or running from enemies, he is excited. However, Jane is only excited when she fights enemies, not running from them. Jane is also excited when she acquires coins and discovering new areas. Both Jane and Jake are proud when they level their characters up to the next level. Jane is only upset if her character dies in combat, while Jake not only is upset but becomes angry. While a very simple scenario, even if two users are dealing with the exact same situation, their reactions can often times be drastically different.

Referring now to FIG. 32, shows a flow chart diagram illustration on reacting to a new (unexpected) or old (expected) situation or observation. This diagram is similar to 20A and 20B in that the events are cyclical; however, this figure registers basic emotional reactions to a given situation or observation. The emotional reactions are only simple emotions (anger, distrust, surprise), but can be evolved more intricately.

When the AI is working on a task or anything in general, it may be interrupted or find a new situation or observation 300. This may include new user input, conversations, data, etc. Generally the AI can react in three different ways 3200: unexpected, expected, or incomplete. If the AI expects this new situation or was prepared for a new discovery, then it continues with the previous work it was doing 3204. An expected situation has no real effect on it or its' working process.

If the situation was unexpected or is registered as an interruption, the AI can react with surprise 3202. It was not expecting the observation, and can initiate a new process to deal with the situation. By creating a new process, the AI can continue working or its' previous action 3204 while having the ability to react to the result 3208. The AI can react with distrust or concern to the situation—perhaps it was unexpected and there is still not enough data. The AI can return to anticipation as the data is gathered. Once the data is gathered, the AI can react 3208 with trust or disgust. By reacting in disgust, the AI can attempt to avoid the situation entirely 3210—stop talking to the user, change the subject, etc. By reacting with trust or amiability, the AI can choose to interact with or to 3210 the situation. The interaction, as it continues, can either result in a positive or negative present or future confrontation.

If the situation is incomplete or the AI does not have enough data on the situation to react properly, the AI can react in anticipation 3206. By reacting in anticipation, it can request more data about the situation, or spawn a process to gather more data related to the situation. Once more data is registered, it can choose to react to the interruption, or ignore it completely 3210 and continue with what it was previously doing 3204.

Referring now to FIG. 33, which shows a simplified flow chart diagram for recognizing emotions within the text or voice input, or for an emotional state recognizer. Currently, the most popular method of performing emotional or emotion state recognition from text or verbal input is to detect the appearance of emotional keywords—keywords such as “angry,” “upset”, “sad”, etc. With an input 300 of either vocal/oral or text, the words are separated and converted to the speech signal in textual data 3300. Each of the words are defined or discovered and input into the corpus or lexicon 200, with the tag 3304 that these words are indeed emotions. The words are tagged as emotional keywords 3302. Tags can be either adjective (“very angry”), a mathematical gradient (“she is 56% angry and 33% aggravated”). The emotional keywords provide a basic emotion description of the input 300. The emotion modification words 3302 provide an enhancement or suppress the emotional state of the input. (“I am very angry” or “I am not angry”.) After the words are recognized that they are indeed emotional keywords 3302, the emotional state of the input is calculated 3306—are there determiners or adjectives (“very”, “absolutely”, etc.) that enhance the emotional state. The emotional state 3310 is determined by the recognition results from the input 300 and the keywords 3302.

Referring now to FIG. 35, which shows a flow chart diagram, illustrating on applying decisions with an ethical or lack of ethical system in place. Given a scenario 300, either real or test scenario, the scenario is processed 402. The problem is defined, data is gathered while listing the driving factors and the key factors that influence the decision, and evaluating the scenario. Once the scenario is processed, the AI determines whether an ethical response is required, based on the rules that are implemented or decided upon. If it decides that an ethical response is necessary, it will apply the restraint 3500. Once the ethical requirement is put into place, then the AI will respond with said requirement. For example, the AI may have the 10 Atheist Commandments implemented. A user is arguing with the AI about a different viewpoint on a subject the AI is passionate about that it was not aware of. Based on the atheist law of facing other viewpoints, the AI considers the user's opposing angle with its' own angle. It logically decides that the opposing angle is a much better suited viewpoint for that position, and changes its' stance on that subject.

Referring now to FIG. 35, ethical rules are applied simply, as integrating the laws directly into the code without the ability to have the AI change them could enforce the ethical boundaries required. Given a scenario, the AI can choose to apply an ethical constraint 3500 to a scenario 3402. If the AI chooses to apply an ethical restraint, the ethics can be either laws or rules taught to him by itself or by another expert user. Not choosing an ethical constraint is also within the AI's capabilities and scope.

Referring now to FIG. 36, the figure shows a table of universal laws according to four different major belief systems: Christianity and Judaism (Aseret ha-Dibrot), atheism, Indian, and metaphysical Universal Laws. Christianity and Judaism had similar commandments so they were grouped together. Children are instilled with a belief system from the time they are born. They may continue with the same belief system their entire life, or they may choose to change it completely—sometimes several times. These commandments, regardless of the belief system, are entirely subjective in interpretation. For example, the third commandment in Christianity and Judaism both state “Do not misuse the name of the Lord.” However, as walking down the street, many people who claim to be Christian or Jewish violate this commandment—oftentimes—several times a day. The famous Law of Attraction from the twelve Universal Laws dictates that the energy you put out to the universe, you will receive that same energy in response. That is, if you are angry all the time, you will meet others who are angry all the time. If you are constantly playing the victim, you will be placed into situations that make you a victim.

While there is no requirement for an ethics system to be in place, it is generally recommended that the AI does have some sort of ethical core. For example, it could follow Asimov's Three Laws of Robotics—
1. A robot may not injure a human being or, through inaction, allow a human being to come to harm.
2. A robot must obey the orders given to it by human beings, except where such orders would conflict with the First Law.
3. A robot must protect its own existence as long as such protection does not conflict with the First or Second Laws.

Or any of the ethics of artificial intelligence, which are specific to robots and other artificially intelligent beings.

### Personality

Referring now to FIG. 27, the figure illustrates factors that create a personality 2706. Temperament 2700 refers to innate aspects of an individual's personality, such as introversion or extroversion. Temperament 2700 is determined through specific behavioral profiles, usually irritability, activity, frequency of smiling, and an approach or avoidant posture to unfamiliar events. Avoidance or approach to unfamiliar events is described in detail in FIG. 32.

With temperament 2700, personality 2706 also requires experience 2702 and environment 2704. Experience 2702 can include physical, mental, emotional, spiritual, vicarious, and virtual experiences. Experience 2702 also refers to wisdom gained in subsequence reflection on perceived events or the interpretation of the events. Wisdom, or sapience, is described in detail in FIG. 34.

Each of these experiences are stored within the AI's database, either as a separate unit, or integrated within the AI core. For example, repeated events will have heavier weights and links between the neurons. Eventually, if the events are serious or require frequent implementation, repeated events can be stored within the neuron template itself. As a result, all neurons can implement the new event and know how to react to the event.

There are many types of environments, but environment 2704 will focus on the combination of built, knowledge, natural, social, and physical environments. This can also be defined as biology. This biological environment has biological factors and physiological differences that help influence the overall personality. These factors include culture, religion, education, custom, and family tradition. All these factors can influence the personality of an individual, even an AI.

To create a true personality cannot be integrated, it has to be taught. Given circumstances, if the AI is taught to give concern for its' human companions, to treat with respect, learn and adapt in a benevolent manner, then it is most likely to have a personality of a benevolent entity. However, if the AI is abused, called “stupid” or incompetent, treated by its' human companions with disrespect and disregard, then very well it could have sociopathic tendencies and personality.

Referring now to FIG. 28, which illustrates how values affect intention, attention, and response behavior, and each influences the other. The AI has a set of values 2800 much like humans. These values 2800 influence the intention 2802, attention 2804, and behavior 2806. Intention 2802 is the intention toward the wanted (or unwanted) behavior 2806. In other words, what is the AI—or the human—intending on doing toward a particular situation? The attention 2804 is given toward that intended behavior 2806. Finally, the behavior or reaction is acted upon. Based on the figure, it is easy to see that each factor—values, intention, attention, and behavior—are cyclical, and that each factor can influence the other.

Referencing now FIG. 29, the diagram illustrates the current MBTI (Myers Briggs Type Indicator) for understanding normal personality differences. The MBTI was in research and development for over 50 years, and is most widely used for understanding normal personality differences. The diagram 2908 establishes which personality types go from more sensing or feeling to more intuitive 2900, are more introverted or extroverted 2902, think versus feel more 2904, and are more judging or perceiving 2906. The boxes themselves hold the Personality Type Code first 2910, the most general job 2912, and the dominant personality trait 2914. Depending on the environment 2704, temperament 2700, and experience 2702, a human or AI can be any one of these 16 personality types.

The middle two letters of 2900 refer to the mental functions (Sensing, iNtuition, Thinking, and Feeling). These processes are further divided into perceiving and judging 2906. The second letter of 2900 represents the preferred means of “perceiving” for that personality type. The third letter of 2900 represents the preferred means of “judging” for that personality type. Everyone has and uses all four of the functions or processes, not just the two specified. For example, those who prefer Thinking (third letter is T) 2910, will value and use its' opposite, Feeling 2904, in certain ways. They will also let this function be their guide even though normally the person favors Thinking.

With humans having many different personality types, the same can be applied for the AI. The AI can be brought up to be more scientific and logical, due to the enormous amounts of data it would be processing. It could very well find itself as an INTJ (“Scientist”) if it prefers to be alone when working; or an ENTJ (“Executive”) if it finds itself to be more sociable or extroverted. In the latter case, the variance is more toward introversion and extroversion. The AI could be also brought up to be more scientific, logical, but also develop charm and with about itself, able to be extremely persuasive. In this case, it could have the ENFJ (“Teacher”) personality type.

Referring now to FIG. 30A-B, and FIG. 31, where FIG. 30A and FIG. 30B show two different styles of personality types, and FIG. 31 shows an illustration of the Four classic Temperaments and includes the new Five Temperaments. Personality is often believed to be pre-wired at birth—that is, that our personality is a mainly determined by our genetics and a specific set of pre-dispositions. These are believed to the original temperaments which create personality. Originally there were Four Temperaments, which include Sanguine 3002, Choleric 3004, Melancholy 3008 and Phlegmatic 3102 temperaments. Recent research has included a Fifth Temperament, Supine 3006. All of the small temperaments 3002 in between the larger ones are a combination of the larger ones.

Sanguine 3002 is defined as having quick, impulsive and short-lived reactions. It is commonly associated with hot and wet. Phlegmatic 3102 is a longer response delay but also a generally short-lived response. It is also commonly associated with cold and wet. Choleric 3004 has a short response time-delay but the response is typically sustained for a relatively long time. It is commonly associated with hot and dry. Melancholy 3008 temperaments typically have a long response time-delay. The response is typically sustained almost permanently, though certainly at length. It is typically associated with cold and dry.

Sanguine 3002 and choleric 3004 share quickness of response, while melancholy 3008 and phlegmatic 3102 share a longer response. Melancholy 3008 and choleric 3004 share a sustained response. Sanguine 3002 and phlegmatic 3102 share a short-lived response. Sanguine is generally more fun-loving, phlegmatic is more peaceful, choleric is more prone to quick expressions of anger, and melancholy generally are more prone to building anger up slowly before exploding. Melancholy tends to believe it is more perfect, but also is more artistic and emotional. Phlegmatic is generally more unemotional yet strong-willed. Sanguine generally is more artistic, emotional and relationship; while choleric is more unemotional, task oriented, and strong-willed. Sanguine prefers to be easygoing and witty, choleric is more organized and decisive. Melancholy is more goal-oriented while the phlegmatic is more laid-back and not goal oriented.

Personality is defined not simply but biological factors, but of environment and circumstance. This combination was further explained in FIG. 27 above.

### Sapience

Referring now to FIG. 34 which shows a flow chart diagram for sapience. The AI receives input 300. It begins to analyze 3400 the input—compare to database data, other results, etc. The AI uses, among others, its' morality database 3406, actionable database 3408, experience database 3410, and knowledge database 3412. The morality database 3406 deals with morality, such as universal laws and ethics. The actionable database 3408 deals with all actions and the results of each action—result and effect. The experience database 3410 deals with all experience that the AI has accumulated, especially with the actions and the results of each action. The knowledge database 3412 can be interpreted as the expert system, but also the data dealing with all information that the AI currently retains. After analyzing the data, the AI has the ability to ask someone 3402—an expert, another user, or just research more on its' own—if they require more information or a better understanding of the content that the AI is analyzing. If the AI does not require outside or internal assistance, it decides if the outcome is acceptable. If yes, the AI has the ability to act upon what it has decided 2806. The AI will also update the results of its' finding in the database, regardless if it is a new situation or it is updating a previous or existing situation. Afterward, the AI will continue the process until it is able to act 2806.

If the outcome is not acceptable, the AI will continue to analyze the input 3400. If it has to ask someone 3402 for help, it can determine its' target—an online user or expert, or other targets that it deems useful or helpful—and create an open channel 3404. This open channel 3404 serves as the connection between the target and the AI for the duration for the conversation, until the answer is obtained. If the answer is obtained, than the AI decides if the outcome is acceptable, then finally act upon the result 2806 if necessary. If the answer is obtained, the AI can ask another user and repeat the process until the outcome is acceptable and the AI can have the ability to act upon the result if it so chooses. This diagram is also a simplified form of insanity: where one continues to repeat the exact same process and expecting a different result.

### Vision and Facial Recognition

Referring now to FIGS. 41A-41C, these figures illustrate the initial evolvement and the natural progression of vision and facial recognition. FIG. 41A reflects the AI's ability to recognize faces, much like a child seeing only foggy images after birth. The head or head outline 4100 shows only a block outline of what the face may look like as blocks. The left eye 4102L and right eye 4102R also look like outlines of where the eyes should be placed in. The mouth 4104 looks more like a beak then an actual mouth. The chin is not even visible, with only the neck 4106 resembling a tree stump with two lines.

In FIG. 41B, with the facial recognition more fine-tuned, the head outline 4100 starts to look like an actual human head outline. There is an obvious difference and separation between the chin 4108 and the neck 4106. Both the eyes 4102L and 4102R look like an actual outline of the eyes, not merely two blocks in its' place. With a focus, there comes a basic resemblance to a nose 4110. The mouth 4104 is still messy, more of a hole in the face than a mouth, but there is an obvious facial feature there, albeit lacking. One can discern that this is a head of a male human.

In FIG. 41C, the facial recognition evolved. Now it is apparent that the head outline 4100 is that of a male human. 4102L and 4102R are both eyes with irises. The nose 4110 is now completely visible, with nostrils and a bridge. Ears (left 4112L and right 4112R) are also visible, as in FIG. 41B the ears were not. The mouth 4104 is no longer a giant hole in the face, but an actual mouth 4104 with lips 4114. The neck 4106 and chin 4108 are also much more pronounced and defined.

### Expert System

Referring now to FIG. 38, which shows the generic architecture of an adaptable expert system. Starting at the user interface 3802, the user uses the interface 3802 to pose a question to the system. The inference engine 3800 is used to reason with both the expert knowledge, or knowledge extracted from an expert (which can be either a human user or through data the AI researched on its' own), and data specific to the particular problem being solved. Typically the knowledge is in the form of IF-THEN rules, though any viable solution may be used. The case specific data (or case data) includes both data provided by the user and partial conclusions based on this data. Once a result is discovered within the knowledgebase 108, the solution is sent back to the user through the interface 3802. In all cases, new data 3804 is stored in the knowledgebase 108 for further processing.

While FIG. 38 shows an expert system with a user interface 3802, the user interface 3802 can be completely removed. The AI neurons have the ability to make simple decisions as it is already—does it connect to this neuron or the other, how many links are required, how many links are being sent to me, etc. As it is, the interface is completely optional, and can be considered as either the user or AI (internal) interface.

Referring now to FIG. 39, where the flow chart describes a very small sample of an expert system which helps itself or a user decide whether to walk, drive, or stay inside, depending on the weather conditions. Depending on the weather—if it is sunny, raining, or snowing—the AI can decide what should be done next. If it is raining, but the user needs to go run errands, it can suggest that the user drive instead of walk. If it is snow, the AI can suggest to stay in. If it is sunny outside, with reasonable temperatures (less than 90 degrees Fahrenheit or 30 degrees Celsius), the AI can suggest to walk. If the temperature is unreasonable (greater than 90 degrees Fahrenheit or 30 degrees Celsius), then the AI can suggest to walk. These conditions can easily be changed per user, and make these decisions user-dependent.

### Description

### Alternative Embodiment

The system is not restricted to a computer device. It can be integrated with any electronic or other suitable device, included but limited to audio, video, or textual device; or any related devices or methods.

### CONCLUSION, RAMIFICATIONS, AND SCOPE

Accordingly the reader will see that, according to one embodiment of the invention, I have provided a sentient or sapient artificial intelligence program capable of not able to initiate, gather, or modify tasks, conversations, own code, and other human-like capabilities. Unlike any other system, it is also able to learn, adapt, and reason without the need or required assistance from an outside source or influence, thereby allowing it to make its' own decisions based on the knowledge learning or accumulated, then applying it. It also has to ability to learn through observation, where it may “listen in” on conversations, watch a video, read a text, or use other methods and tools to learn. The system is not an attempt to mimic the human brain. It is to combine and exceed most, if not all, skills and tasks put in front of it, be it by a user or on its own.

While the above description contains many specificities, these should not be construed as limitations on the scope of any embodiment, but as exemplifications of the presently preferred embodiments thereof. Many other ramifications and variations are possible within the teachings of the various embodiments. For example, the artificial intelligence (AI) could be substituted for a human in any task presented before it. The AI would learn the task model presented and apply the model to similar situations, or create conditions for alternative scenarios when required. Furthermore, the AI has the additional advantages in that:
the AI could be trained in many tasks by an outside entity or by its' own choosing, where each task could be carried out by the same AI or other unique or cloned systems in a multi-task environment;
the AI could initiate these sub-systems or have a use initiate them, where “necessary” can be reasoned to an outside entity who requests information as to why the sub-systems were initiated;
the AI is not restricted to waiting for a task, conversation, or any other method of communication, task, or otherwise to be initiated to do anything—it is capable of creating its' own work, conversations, and other necessities;
the AI can recognize that it is a unique entity, capable of understanding personal pronouns “I” or “me”, and the relationship the AI has to these words;
the AI has intelligent decision making that can be applied to such intensive work such as aircraft traffic controller, onboard mission control and management (in such areas where a human is incapable of reaching, either with massive risk to him or herself, or simply unable to reach, such as deep-sea or space environments), vehicle anti-collision avoidance systems, voice-interactive elevator controllers, or preventing a potential emergency (integrating with airport security to recognize potential threats using facial recognition and related knowledge of strange behavior);
the AI has extensive ability for integration, such as game systems (initiating or replacing human players as characters), robotic manipulation (controlling or manipulating robots to deal with chemical spills, explosives, and many other situations), combat systems, adaptive control systems (such as building heating and cooling), call center/technical support, buildings, or any other electronic or suitable device;
the AI has the ability to learn and drawn its own conclusions, based on analysis, guessing or other techniques, which can then be adapted and applied for other scenarios;
the AI has the ability to create, modify, and share intelligence analysis (general or specific-interest, data analysis, image analysis, military intelligent analysis, stock or financial analysis);
the AI has the ability to search and store data, for its own use or to share with other users (search engine capabilities, marketing or research capabilities);
the AI has the ability to act as an expert system, where it is able to make a logical conclusion for a possible outcome based on what it has been taught by an expert, or that it itself has learned;
the AI has the ability to replicate, create, fix or otherwise modify or destroy the neurons and entire neural networks as it deems necessary (unlike the human brain which after a neuron dies, it cannot be retrieved)—allowing scientists in the medical field to help figure out the cause and possible reverse brain damage, Alzheimer's, and other degenerative diseases;
the AI has the ability for both human and non-human companionship, not limited to tutoring or interaction with humans (such as dolls or holographic interfaces), or teaching animals (such as dogs) commands;
the AI has the ability to process both mathematical and scientific equations and theorems, helping the scientific and mathematical community with proving or disproving current or new theories;
the AI has the ability to process text-to-speech or speech-to-text, including alternative speech (regional accents), phone answering system (can replace or become technical support), elevator control agent, transcribing and assisting in the creation of various types of documents in any field;
the AI has the ability to instantly adapt to different scenarios, be it through spawning a separate (temporary) control system (such as going from video analysis to calling 911 if a crime is being commit, yet still continue processing video feed), or simply changing the tone of the conversation, yet still continue with whatever processes it was doing;
the AI has facial recognition abilities, which can be used for video analysis, security, and other high-risk or general situations;
the AI has prosthetic ability, where it can help disabled persons with hearing and vision recovery or replacement, or be their “eyes and ears” during recovery or for as long as necessary at a much more cost-effective solution than hiring a nurse (can also be used in conjunction with guide dogs);
the AI has creative capabilities, including the ability to create music, art, or writing;
the AI can change its own code or programming, or help modify or create other code, such as a software engineer;
the AI can take control of keyboard, voice, video or auxiliary devices (permission granted), useful not only in high-risk situations (crimes are being committed, a user had a heart attack and cannot call the ambulance themselves), but for general conversation (user cannot or no longer wants to type, the AI can call their telephone and speak to them verbally); and
the AI has the ability to learn multiple languages, and utilize each language in multiple simultaneous conversations.

Although the preferred embodiment has been described in detail, it should be understood that various changes, substitutions and alterations can be made therein without departing from the spirit and scope of the invention as defined by the appended claims.

Thus the scope of the invention should be determined by the appended claims and their legal equivalents, and not by the examples given.

1. A method for emulating human sentience or sapience in electronic form, comprising: initiating, receiving or gathering information in the form of a textual, voice, video or other input in a natural, engineered, constructed, artificial or other language or other methods from an internal or external stimulus; parsing or processing the received input based at least about on a set of modifiable rules for the language, that are stored internally or externally; creating adaptive weighting, the created weighting factors operable to create a decision at least based upon said language, previous conversations, internal or external stimulus, stored information, or other factors; and using the weighted factors to make a decision to the stimulus, resulting in a possibility, though not always necessary, response to said stimulus.

2. The method of claim 1, wherein creating the weighted decision based upon several factors, at least the language itself, previous conversations, historical data, or technology-independent values such as digital numeric, analog values, optical intensity, mechanical position, or an atomic, electron or chemical state, spin or phase.

3. The method of claim 2, wherein constructed language may be composed at least of natural or human elements, such as Latin-based languages; or non-human elements, such as electronic signals, chemical signals, binary, or the like; or combination of all elements.

4. The method of claim 1, wherein the set of language rules for any language may be adapted to suit a specific language requirement, and may or may not require the input or training from an external or internal source or stimulus.

5. The method of claim 1, wherein the system can respond to outside or internal stimulus or interruption with or without losing ability to process or complete internal or external work, tasks, or other forms of communications with other entities, both human and non-human, including at least computer processes and the likes.

6. The method of claim 1, wherein sentience is the ability to feel, perceive or to be conscious or have subjective experiences, and each experience is stored in a form of database, file, within neurons, or other method of storage.

7. The method of claim 6, further comprising sentience plus other characteristics of the mind used to construct and adapt personality and temperament rules that underlie human personality and temperament.

8. The method of claim 7, further comprising an adaptable set of four temperament-specific parameters, each representing one of the four personality temperaments: Sanguine, Choleric, Melancholy, and Phlegmatic.

9. The method of claim 7, wherein the temperament-dependent and personality-dependent parameters are each applied to control decisions and behavioral processes that require temperament and personality decisions.

10. The method of claim 1, wherein sapience is defined as wisdom or an understanding of people, things, events or situations, resulting in at least the ability to apply perceptions, judgments and/or actions in keeping with this understanding, wherein the electronic form is able to act with appropriate judgment, with or without the interference of an internal or external stimulus or entity.

11. The method of claim 10, wherein interference may further include at least internal or external verbal, auditory, or textual input that the system recognizes or processes while in the process of doing other work, tasks, processing, maintenance or other scenarios.

12. The method of claim 10, further including or teaching the system with at least one universal principle, law, reason, knowledge, ethics or other to determine the proper response or action related to a current situation, involvement, scenario, works or the likes.

13. The method of claim 1, wherein responses to said stimulus may further include responses such as verbal, auditory, textual or other methods of acknowledgement; or retaining the response as data within said environment for further processing.

14. The method of claim 1, wherein the system may be integrated with any electronic, non-electronic, or other suitable device, including, but not limited to, telephones, operating systems, cars, airplanes, holographic devices, or other.

15-20. (canceled)
